(19) United States
(12) Patent Application Publication
(10) Pub. No.: US 2025/0193831 A1
(43) Pub. Date: Jun. 12, 2025

(54) POSITIONING WITH RADIO AND VIDEO-BASED CHANNEL STATE INFORMATION (VCSI) FUSION

(71) Applicant: QUALCOMM Incorporated, San Diego, CA (US)

(72) Inventors: Alexandros MANOLAKOS, Athens, Attikí (GR); Duo ZHANG, San Diego, CA (US); Fei HUANG, San Diego, CA (US); Xipeng ZHU, San Diego, CA (US); Wei ZOU, San Diego, CA (US)

(21) Appl. No.: 18/847,210

(22) PCT Filed: Feb. 17, 2023
(86) PCT No.: PCT/US2023/062820

§ 371 Date: Sep. 13, 2024

(30) Foreign Application Priority Data
May 4, 2022 (GR) 20220100367

(51) Int. Cl. H04W 64/00; H04B 7/06; H04W 8/22; H04W 92/18

(52) U.S. Cl. CPC H04W 64/00; H04B 7/0626; H04W 8/22; H04W 92/18

(57) ABSTRACT

A user equipment (UE) performs combined radio-based positioning techniques and video-based channel state information (vCSI) based positioning techniques. An example method performed by a first UE includes receiving a first request for visual positioning of the first UE, the visual positioning based at least in part on visual signals captured by a visual sensor of the first UE and on one or more radio positioning signals, capturing visual data based on the relative direction, determining video-based channel state information (vCSI) based on the captured visual data, and transmitting the vCSI to a network entity associated with the first UE.

### RELATED APPLICATIONS

This application claims the benefit of Greek Application No. 20220100367, filed May 4, 2022, entitled “POSITIONING WITH RADIO AND VIDEO-BASED CHANNEL STATE INFORMATION (VCSI) FUSION”, which is assigned to the assignee hereof, and incorporated herein in its entirety by reference.

### BACKGROUND

### Field

Subject matter disclosed herein relates to estimation of a location of a mobile device and more particularly to estimating the location of a mobile device based at least in part on captured visual data.

### Information:

The location of a mobile device, such as a cellular telephone, may be useful or essential to a number of applications including emergency calls, navigation, direction finding, asset tracking and Internet service. The location of a mobile device may be estimated based on information gathered from various systems. In a cellular network implemented according to 4G (also referred to as Fourth Generation) Long Term Evolution (LTE) radio access or 5G (also referred to as Fifth Generation) “New Radio” (NR), for example, a base station may transmit a positioning reference signal (PRS). Assistance data is sent to a mobile device to assist in acquiring and measuring signals and/or in computing a location estimate from the measurements, which may be useful for acquiring PRS for location determination. A mobile device acquiring PRSs may compute an estimate of its own location using various positioning methods and report the estimated location to one or more other devices in the network, such as to one or more base stations, location servers, network entities, o other mobile devices. For example, a mobile device may receive assistance data including location information for one or more transmission/reception points (TRPs), and the mobile device may exchange signals with the one or more TRPs and determine its own position based the exchanges signals and the known location of the one or more TRPs. Other position methods that may be used for a mobile device include use of a Global Navigation Satellite System (GNSS) such as GPS, GLONASS or Galileo and use of Assisted GNSS (A-GNSS) where a network provides assistance data to a mobile decide to assist the mobile device in acquiring and measuring GNSS signals and/or in computing a location estimate from the GNSS measurements.

### SUMMARY

A first user equipment (UE) performs positioning techniques incorporating both radio-based positioning and video-based channel state information (vCSI) based positioning. An example method includes receiving a first request for visual positioning of the first UE, the visual positioning based at least in part on visual signals captured by a visual sensor of the first UE and on one or more radio positioning signals, capturing visual data based on the relative direction, determining video-based channel state information (vCSI) based on the captured visual data, and transmitting the vCSI to a network entity associated with the first UE.

In some aspects, the first request may include a relative direction for pointing the visual sensor of the first UE. The first request may further indicate a distance associated with one of the one or more wireless devices. In some aspects, the relative direction indicates at least a threshold distance. In some aspects, the first request further indicates a category of object of interest.

In some aspects, the one or more radio positioning signals are received from one of the one or more wireless devices within visual range of the first UE.

In some aspects, the vCSI may be associated with a presence of at least one of the one or more wireless devices within visible range of the first UE, and the method may further include receiving a request, based at least in part on the vCSI, from a network entity such as a base station or a location server associated with the first UE requesting radio positioning of one of the one or more wireless devices, receiving the one or more radio positioning signals from the at least one of the one or more wireless devices, and transmitting a response to the network entity based at least in part on the one or more radio positioning signals. In some aspects, the relative direction in the first request indicates at least a threshold distance, wherein the vCSI is only determined for objects within the threshold distance of the first UE. In some aspects, the vCSI is determined based on the captured visual data using a trained machine learning model. In some aspects the vCSI is based at least in part on one or more tags indicating one or more zone properties associated with the visual data. In some aspects, the one or more zone properties include one or more of an indoor zone category, an outdoor zone category, a sky zone category, a ground zone category, a reflection zone category, a blockage zone category, a room size zone category. In some aspects, the vCSI is determined based at least in part on a category of object of interest indicated in the first request.

In some implementations, the method may further include receiving, prior to receiving the first request, a sidelink positioning request requesting the first UE to determine positioning information associated with the relative direction, receiving the one or more positioning signals from one of one or more wireless devices within visual range of the first UE, and transmitting a response to the sidelink positioning request associated with the relative direction based at least in part on the one or more radio positioning signals.

In some aspects, the method may further include, prior to receiving the first request, receiving a request for radio-based positioning of the first UE, receiving the one or more radio positioning signals based on the request for radio-based positioning, determining one or more radio positioning measurements based on the one or more radio positioning signals, and transmitting one or more signals to the base station indicating the one or more radio positioning measurements, wherein the first request is based at least in part on the one or more radio positioning measurements. In some aspects, the method may further include receiving one or more signals from the network entity indicating one or more points of interest determined to be proximate to the first UE based on the one or more positioning measurements, wherein the visual data is based at least in part on the one or more points of interest.

In some aspects, the method may further include, prior to receiving the first request, reporting one or more capabilities to the network entity associated with determining the vCSI, the one or more capabilities comprising one or more of a number of cameras coupled to the first UE, one or more visual zoom capabilities associated with the first UE, one or more ranges of motion associated with capturing the visual data, and one or more visual resolutions associated with capturing the visual data.

In one implementation, a first UE configured to perform positioning techniques incorporating both radio-based positioning and video-based channel state information (vCSI) based positioning may include a wireless transceiver configured to wirelessly communicate with entities in the wireless network, at least one memory, and at least one processor coupled to the wireless transceiver and the at least one memory. The at least one processor is configured to: receive a first request for visual positioning of the first UE, the visual positioning based at least in part on visual signals captured by a visual sensor of the first UE and on one or more radio positioning signals, capture visual data based on the relative direction, determine video-based channel state information (vCSI) based on the captured visual data, and transmit the vCSI to a network entity associated with the first UE.

In some aspects, the first request may include a relative direction for pointing the visual sensor of the first UE. The first request may further indicate a distance associated with one of the one or more wireless devices. In some aspects, the relative direction indicates at least a threshold distance. In some aspects, the first request further indicates a category of object of interest.

In some aspects, the one or more radio positioning signals are received from one of the one or more wireless devices within visual range of the first UE.

In some aspects, the vCSI may be associated with a presence of at least one of the one or more wireless devices within visible range of the first UE, and the at least one processor is further configured to receive a request, based at least in part on the vCSI, from a network entity such as a base station or a location server associated with the first UE requesting radio positioning of one of the one or more wireless devices, receive the one or more radio positioning signals from the at least one of the one or more wireless devices, and transmit a response to the network entity based at least in part on the one or more radio positioning signals. In some aspects, the relative direction in the first request indicates at least a threshold distance, wherein the vCSI is only determined for objects within the threshold distance of the first UE. In some aspects, the vCSI is determined based on the captured visual data using a trained machine learning model. In some aspects the vCSI is based at least in part on one or more tags indicating one or more zone properties associated with the visual data. In some aspects, the one or more zone properties include one or more of an indoor zone category, an outdoor zone category, a sky zone category, a ground zone category, a reflection zone category, a blockage zone category, a room size zone category. In some aspects, the vCSI is determined based at least in part on a category of object of interest indicated in the first request.

In some implementations, the at least one processor is further configured to receive, prior to receiving the first request, a sidelink positioning request requesting the first UE to determine positioning information associated with the relative direction, receive the one or more positioning signals from one of one or more wireless devices within visual range of the first UE, and transmit a response to the sidelink positioning request associated with the relative direction based at least in part on the one or more radio positioning signals.

In some aspects, the at least one processor is further configured to, prior to receiving the first request, receive a request for radio-based positioning of the first UE, receiving the one or more radio positioning signals based on the request for radio-based positioning, determine one or more radio positioning measurements based on the one or more radio positioning signals, and transmit one or more signals to the base station indicating the one or more radio positioning measurements, wherein the first request is based at least in part on the one or more radio positioning measurements. In some aspects, the at least one processor is further configured to receive one or more signals from the network entity indicating one or more points of interest determined to be proximate to the first UE based on the one or more positioning measurements, wherein the visual data is based at least in part on the one or more points of interest.

In some aspects, the at least one processor is further configured to, prior to receiving the first request, report one or more capabilities to the network entity associated with determining the vCSI, the one or more capabilities comprising one or more of a number of cameras coupled to the first UE, one or more visual zoom capabilities associated with the first UE, one or more ranges of motion associated with capturing the visual data, and one or more visual resolutions associated with capturing the visual data.

In one implementation, an example method is performed by a base station associated with the first UE, and includes transmitting, to the first UE, a first request for visual positioning of the first UE, the visual positioning based at least in part on visual signals captured by a visual sensor of the first UE and on one or more radio positioning signals. For example, the first request may indicate a relative direction for pointing the visual sensor of the first UE. The first request may further include a distance associated with one of the one or more wireless devices. In some aspects, the relative direction indicates at least a threshold distance. In some aspects, the first request further indicates a category of object of interest.

The method further includes receiving video-based channel state information (vCSI) from the first UE, where the vCSI is based at least in part on the visual signals captured by the first UE. In some aspects, the visual data is associated with one or more wireless devices within visual range of the first UE. In some aspects, the vCSI is determined based on the captured visual data using a trained machine learning model. In some aspects, the vCSI is based at least in part on one or more tags indicating one or more zone properties associated with the visual data. In some aspects, the one or more zone properties include one or more of an indoor zone category, an outdoor zone category, a sky zone category, a ground zone category, a reflection zone category, a blockage zone category, a room size zone category. In some aspects, the vCSI is determined based at least in part on a category of object of interest indicated in the first request.

The method further includes transmitting the vCSI to a location server coupled to the base station.

In some aspects, the method further includes, prior to transmitting the first request, transmitting a request for radio-based positioning of the first UE, and receiving one or more signals from the first UE based on the one or more radio positioning signals, the one or more radio positioning signals indicating one or more positioning measurements performed by the first UE, wherein the first request is based at least in part on the one or more positioning measurements. In some aspects, the method further includes transmitting one or more signals to the first UE indicating one or more points of interest determined to be proximate to the first UE based on the one or more positioning measurements, wherein the visual data is based at least in part on the one or more points of interest.

In some aspects, the method further includes prior to transmitting the first request, receiving one or more messages from the first UE indicating one or more capabilities of the first UE associated with determining the vCSI, the one or more capabilities comprising one or more of a number of cameras coupled to the first UE, one or more visual zoom capabilities associated with the first UE, one or more ranges of motion associated with capturing the visual data, and one or more visual resolutions associated with capturing the visual data.

In one implementation, a base station associated with a first UE includes a wireless transceiver configured to wirelessly communicate with entities in the wireless network, at least one memory, and at least one processor coupled to the wireless transceiver and the at least one memory. The at least one processor is configured to transmit, to the first UE, a first request for visual positioning of the first UE, the visual positioning based at least in part on visual signals captured by a visual sensor of the first UE and on one or more radio positioning signals, receive video-based channel state information (vCSI) from the first UE, the vCSI based at least in part on the visual signals captured by the first UE, and transmit the vCSI to a location server coupled to the base station.

In some aspects, the first request may indicate a relative direction for pointing the visual sensor of the first UE. The first request may further include a distance associated with one of the one or more wireless devices. In some aspects, the relative direction indicates at least a threshold distance. In some aspects, the first request further indicates a category of object of interest.

In some aspects, the visual data is associated with one or more wireless devices within visual range of the first UE. In some aspects, the vCSI is determined based on the captured visual data using a trained machine learning model. In some aspects, the vCSI is based at least in part on one or more tags indicating one or more zone properties associated with the visual data. In some aspects, the one or more zone properties include one or more of an indoor zone category, an outdoor zone category, a sky zone category, a ground zone category, a reflection zone category, a blockage zone category, a room size zone category. In some aspects, the vCSI is determined based at least in part on a category of object of interest indicated in the first request.

In some aspects, the at least one processor is further configured to, prior to transmit the first request, transmitting a request for radio-based positioning of the first UE, and receive one or more signals from the first UE based on the one or more radio positioning signals, the one or more radio positioning signals indicating one or more positioning measurements performed by the first UE, wherein the first request is based at least in part on the one or more positioning measurements. In some aspects, the at least one processor is further configured to transmit one or more signals to the first UE indicating one or more points of interest determined to be proximate to the first UE based on the one or more positioning measurements, wherein the visual data is based at least in part on the one or more points of interest.

In some aspects, the at least one processor is further configured to, prior to transmitting the first request, receive one or more messages from the first UE indicating one or more capabilities of the first UE associated with determining the vCSI, the one or more capabilities comprising one or more of a number of cameras coupled to the first UE, one or more visual zoom capabilities associated with the first UE, one or more ranges of motion associated with capturing the visual data, and one or more visual resolutions associated with capturing the visual data.

In one implementation, an example method is performed by a location server associated with the first UE, and includes transmitting, to the first UE, a first request for visual positioning of the first UE, the visual positioning based at least in part on visual signals captured by a visual sensor of the first UE and on one or more radio positioning signals, receiving video-based channel state information (vCSI) from the first UE, where the vCSI is based at least in part on the first request and on visual data captured by the first UE, and determining a location of the first UE based at least in part on the one or more radio positioning signals and the vCSI.

In some aspects, the first request may indicate a relative direction for pointing the visual sensor of the first UE. The first request may further include a distance associated with one of the one or more wireless devices. In some aspects, the relative direction indicates at least a threshold distance. In some aspects, the first request further indicates a category of object of interest.

In some aspects, the visual data is associated with one or more wireless devices within visual range of the first UE. In some aspects, the vCSI is determined based on the captured visual data using a trained machine learning model. In some aspects, the vCSI is based at least in part on one or more tags indicating one or more zone properties associated with the visual data. In some aspects, the one or more zone properties include one or more of an indoor zone category, an outdoor zone category, a sky zone category, a ground zone category, a reflection zone category, a blockage zone category, a room size zone category. In some aspects, the vCSI is determined based at least in part on a category of object of interest indicated in the first request.

In some aspects, the method further includes, prior to transmitting the first request, transmitting a request for radio-based positioning of the first UE, and receiving one or more signals from the first UE based on the one or more radio positioning signals, the one or more radio positioning signals indicating one or more positioning measurements performed by the first UE, wherein the first request is based at least in part on the one or more positioning measurements. In some aspects, the method further includes transmitting one or more signals to the first UE indicating one or more points of interest determined to be proximate to the first UE based on the one or more positioning measurements, wherein the visual data is based at least in part on the one or more points of interest.

In some aspects, the method further includes prior to transmitting the first request, receiving one or more messages from the first UE indicating one or more capabilities of the first UE associated with determining the vCSI, the one or more capabilities comprising one or more of a number of cameras coupled to the first UE, one or more visual zoom capabilities associated with the first UE, one or more ranges of motion associated with capturing the visual data, and one or more visual resolutions associated with capturing the visual data.

In one implementation, a location server associated with a first UE includes a wireless transceiver configured to wirelessly communicate with entities in the wireless network, at least one memory, and at least one processor coupled to the wireless transceiver and the at least one memory. The at least one processor is configured to transmit, to the first UE, a first request for visual positioning of the first UE, the visual positioning based at least in part on visual signals captured by a visual sensor of the first UE and on one or more radio positioning signals, receive video-based channel state information (vCSI) from the first UE, where the vCSI is based at least in part on the first request and on visual data captured by the first UE, and determine a location of the first UE based at least in part on the one or more radio positioning signals and the vCSI.

In some aspects, the first request may indicate a relative direction for pointing the visual sensor of the first UE. The first request may further include a distance associated with one of the one or more wireless devices. In some aspects, the relative direction indicates at least a threshold distance. In some aspects, the first request further indicates a category of object of interest.

In some aspects, the visual data is associated with one or more wireless devices within visual range of the first UE. In some aspects, the vCSI is determined based on the captured visual data using a trained machine learning model. In some aspects, the vCSI is based at least in part on one or more tags indicating one or more zone properties associated with the visual data. In some aspects, the one or more zone properties include one or more of an indoor zone category, an outdoor zone category, a sky zone category, a ground zone category, a reflection zone category, a blockage zone category, a room size zone category. In some aspects, the vCSI is determined based at least in part on a category of object of interest indicated in the first request.

In some aspects, the at least one processor is further configured to, prior to transmitting the first request, transmit a request for radio-based positioning of the first UE, and receive one or more signals from the first UE based on the one or more radio positioning signals, the one or more radio positioning signals indicating one or more positioning measurements performed by the first UE, wherein the first request is based at least in part on the one or more positioning measurements. In some aspects, the at least one processor is further configured to transmit one or more signals to the first UE indicating one or more points of interest determined to be proximate to the first UE based on the one or more positioning measurements, wherein the visual data is based at least in part on the one or more points of interest.

In some aspects, the at least one processor is further configured to, prior to transmitting the first request, receive one or more messages from the first UE indicating one or more capabilities of the first UE associated with determining the vCSI, the one or more capabilities comprising one or more of a number of cameras coupled to the first UE, one or more visual zoom capabilities associated with the first UE, one or more ranges of motion associated with capturing the visual data, and one or more visual resolutions associated with capturing the visual data.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an exemplary wireless communications system, according to various aspects of the disclosure.

FIGS. 2A and 2B illustrate example wireless network structures, according to various aspects of the disclosure.

FIG. 3 illustrates a block diagram of a design of base station and user equipment (UE), which may be one of the base stations and one of the UEs in FIG. 1.

FIG. 4 shows a structure of an exemplary subframe sequence for a positioning reference signal (PRS).

FIG. 5 shows a time sequence diagram depicting a UE generating and reporting vCSI based on captured visual data.

FIG. 6 shows an example time sequence diagram for radio-positioning assisted vCSI determination, according to some implementations.

FIG. 7 shows an example time sequence diagram for radio-positioning assisted vCSI determination, according to some implementations.

FIG. 8 shows an example time sequence diagram for radio-positioning assisted vCSI determination, according to some implementations.

FIG. 9 shows a schematic block diagram illustrating certain exemplary features of a UE, e.g., which may be UE 104 shown in FIG. 1, enabled to support positioning of the UE using radio based CSI and vCSI, as described herein.

FIG. 10 shows a schematic block diagram illustrating certain exemplary features of a location server, e.g., location server 172, enabled to support positioning of the UE using relative location information messages, as described herein.

FIG. 11 shows a schematic block diagram illustrating certain exemplary features of a base station, e.g., base station 102 in FIG. 1, enabled to support positioning of the UE using relative location information messages, as described herein.

FIG. 12 shows a flowchart for an exemplary method for supporting positioning of a first user equipment (UE) in a wireless network performed by the first UE, such as UE 104, in a manner consistent with disclosed implementation.

FIG. 13 shows a flowchart for an exemplary method for supporting positioning of a first user equipment (UE) in a wireless network performed by a serving base station in the wireless network, such as base station 102 shown in FIG. 1, in a manner consistent with disclosed implementation.

FIG. 14 shows a flowchart for an exemplary method for supporting positioning of a first user equipment (UE) in a wireless network performed by a location server associated with the UE in the wireless network, such as location server 172, in a manner consistent with disclosed implementation.

### DETAILED DESCRIPTION

Aspects of the disclosure are provided in the following description and related drawings directed to various examples provided for illustration purposes. Alternate aspects may be devised without departing from the scope of the disclosure.

Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular Radio Access Technology (RAT), unless otherwise noted. In general, a UE may be any wireless communication device (e.g., a mobile phone, router, tablet computer, laptop computer, a consumer asset tracking device, a consumer wearable (e.g., smartwatch, glasses, augmented reality (AR)/virtual reality (VR) headset, etc.), a navigation device for a vehicle (e.g., automobile, motorcycle, bicycle, etc.), devices and appliances connected to the internet as a part of the Internet of Things (IoT) device, etc.) used by a user to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” “mobile device,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11, etc.) and so on.

A base station may operate according to one of several RATs in communication with UEs depending on the network in which it is deployed, and may be alternatively referred to as an access point (AP), a network node, a NodeB, an evolved NodeB (eNB), a New Radio (NR) Node B (also referred to as a gNB), etc. In addition, in some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an UL/reverse or DL/forward traffic channel.

The term “base station” may refer to a single physical transmission point or to multiple physical transmission points that may or may not be co-located. For example, where the term “base station” refers to a single physical transmission point, the physical transmission point may be an antenna of the base station corresponding to a cell of the base station. Where the term “base station” refers to multiple co-located physical transmission points, the physical transmission points may be an array of antennas (e.g., as in a multiple-input multiple-output (MIMO) system or where the base station employs beamforming) of the base station. Where the term “base station” refers to multiple non-co-located physical transmission points, the physical transmission points may be a distributed antenna system (DAS) (a network of spatially separated antennas connected to a common source via a transport medium) or a remote radio head (RRH) (a remote base station connected to a serving base station). Alternatively, the non-co-located physical transmission points may be the serving base station receiving the measurement report from the UE and a neighbor base station whose reference radio frequency (RF) signals the UE is measuring.

To support positioning of a UE, two broad classes of location solution have been defined: control plane and user plane. With control plane (CP) location, signaling related to positioning and support of positioning may be carried over existing network (and UE) interfaces and using existing protocols dedicated to the transfer of signaling.

With user plane (UP) location, signaling related to positioning and support of positioning may be carried as part of other data using such protocols as the Internet Protocol (IP), Transmission Control Protocol (TCP) and User Datagram Protocol (UDP).

The Third Generation Partnership Project (3GPP) has defined control plane location solutions for UEs that use radio access according to Global System for Mobile communications GSM (2G), Universal Mobile Telecommunications System (UMTS) (3G), LTE (4G) and New Radio (NR) for Fifth Generation (5G). These solutions are defined in 3GPP Technical Specifications (TSs) 23.271 and 23.273 (common parts), 43.059 (GSM access), 25.305 (UMTS access), 36.305 (LTE access) and 38.305 (NR access). The Open Mobile Alliance (OMA) has similarly defined a UP location solution known as Secure User Plane Location (SUPL) which can be used to locate a UE accessing any of a number of radio interfaces that support IP packet access such as General Packet Radio Service (GPRS) with GSM, GPRS with UMTS, or IP access with LTE or NR.

Both CP and UP location solutions may employ a location server to support positioning. The location server may be part of or accessible from a serving network or a home network for a UE or may simply be accessible over the Internet or over a local Intranet. If positioning of a UE is needed, a location server may instigate a session (e.g. a location session or a SUPL session) with the UE and coordinate location measurements by the UE and determination of an estimated location of the UE. During a location session, a location server may request positioning capabilities of the UE (or the UE may provide them without a request), may provide assistance data to the UE (e.g. if requested by the UE or in the absence of a request) and may request a location estimate or location measurements from a UE for various positioning techniques, e.g. for the Global Navigation Satellite System (GNSS), Time Difference of Arrival (TDOA), Angle of Departure (AoD), Round Trip Time (RTT) or multi cell RTT (Multi-RTT), and/or Enhanced Cell ID (ECID) position methods. Assistance data may be used by a UE to acquire and measure GNSS and/or PRS signals (e.g. by providing expected characteristics of these signals such as frequency, expected time of arrival, signal coding, signal Doppler).

In a UE based mode of operation, assistance data may also or instead be used by a UE to help determine a location estimate from the resulting location measurements. For example, the assistance data may provide satellite ephemeris data in the case of GNSS positioning or base station locations and other base station characteristics such as PRS timing in the case of terrestrial positioning using, e.g., TDOA, AoD, Multi-RTT, etc.).

In another standalone mode of operation, a UE may make location related measurements without any positioning assistance data from a location server and may further compute a location or a change in location without any positioning assistance data from a location server. Position methods that may be used in a standalone mode include GPS and GNSS (e.g. if a UE obtains satellite orbital data from data broadcast by GPS and GNSS satellites themselves) as well as sensors.

In the case of 3GPP CP location, a location server may be an enhanced serving mobile location center (E-SMLC) in the case of LTE access, a standalone SMLC (SAS) in the case of UMTS access, a serving mobile location center (SMLC) in the case of GSM access, or a Location Management Function (LMF) in the case of 5G NR access.

In the case of OMA SUPL location, a location server may be a SUPL Location Platform (SLP) which may act as any of: (i) a home SLP (H-SLP) if in or associated with the home network of a UE or if providing a permanent subscription to a UE for location services; (ii) a discovered SLP (D-SLP) if in or associated with some other (non-home) network or if not associated with any network; (iii) an Emergency SLP (E-SLP) if supporting location for an emergency call instigated by the UE; or (iv) a visited SLP (V-SLP) if in or associated with a serving network or a current local area for a UE.

During a location session, a location server and UE may exchange messages defined according to some positioning protocol in order to coordinate the determination of an estimated location. Possible positioning protocols may include, for example, the LTE Positioning Protocol (LPP) defined by 3GPP in 3GPP TS 36.355 and the LPP Extensions (LPPe) protocol defined by OMA in OMA TSs OMA-TS-LPPe-V1_0, OMA-TS-LPPe-V1_1 and OMA-TS-LPPe-V2_0. The LPP and LPPe protocols may be used in combination where an LPP message contains one embedded LPPe message. The combined LPP and LPPe protocols may be referred to as LPP/LPPe. LPP and LPP/LPPe may be used to help support the 3GPP control plane solution for LTE or NR access, in which case LPP or LPP/LPPe messages are exchanged between a UE and E-SMLC or between a UE and LMF. LPP or LPPe messages may be exchanged between a UE and E-SMLC via a serving Mobility Management Entity (MME) and a serving eNodeB for the UE. LPP or LPPe messages may also be exchanged between a UE and LMF via a serving Access and Mobility Management Function (AMF) and a serving NR Node B (gNB) for the UE. LPP and LPP/LPPe may also be used to help support the OMA SUPL solution for many types of wireless access that support IP messaging (such as LTE, NR and WiFi), where LPP or LPP/LPPe messages are exchanged between a SUPL Enabled Terminal (SET), which is the term used for a UE with SUPL, and an SLP, and may be transported within SUPL messages such as a SUPL POS or SUPL POS INIT message

A location server and a base station (e.g. an eNodeB for LTE access) may exchange messages to enable the location server to (i) obtain position measurements for a particular UE from the base station, or (ii) obtain location information from the base station not related to a particular UE such as the location coordinates of an antenna for the base station, the cells (e.g. cell identities) supported by the base station, cell timing for the base station and/or parameters for signals transmitted by the base station such as PRS signals. In the case of LTE access, the LPP A (LPPa) protocol may be used to transfer such messages between a base station that is an eNodeB and a location server that is an E-SMLC. In the case of NR access, the NRPPA protocol may be used to transfer such messages between a base station that is a gNodeB and a location server that is an LMF. It is noted that the terms “parameter” and “information element” (IE) are synonymous and are used interchangeably herein.

During positioning using signaling in LTE and 5G NR, a UE typically acquires one or more dedicated positioning signals transmitted by base stations, referred to as Positioning Reference Signals (PRS), which are used to generate the desired measurements for the supported positioning technique. Positioning Reference Signals (PRS) are defined for 5G NR positioning to enable UEs to detect and measure more neighbor base stations or Transmission/Reception Points (TRPs). Several configurations are supported to enable a variety of deployments (indoor, outdoor, sub-6, mmW). To support PRS beam operation, beam sweeping is additionally supported for PRS. Table 1 below illustrates 3GPP release numbers (e.g., Rel.16 or Rel.15) that define particular reference signals for various UE measurements and the accompanying positioning techniques.

TABLE 1

| | | To facilitate |
|---|---|---|
| | | support of the |
| | | following |
| | | positioning |
| DL/UL Reference Signals | UE Measurements | techniques |
| Rel. 16 DL PRS | DL RSTD | DL-TDOA |
| Rel. 16 DL PRS | DL PRS RSRP | DL-TDOA, |
| | | DL-AoD, |
| | | Multi-RTT |
| Rel. 16 DL PRS/Rel. 16 | UE Rx-Tx time | Multi-RTT |
| SRS for positioning | difference | |
| Rel. 15 SSB/CSI-RS | SS-RSRP(RSRP | E-CID |
| for RRM | for RRM), SS-RSRQ | |
| | (for RRM), CSI-RSRP | |
| | (for RRM), CSI-RSRQ | |
| | (for RRM) | |

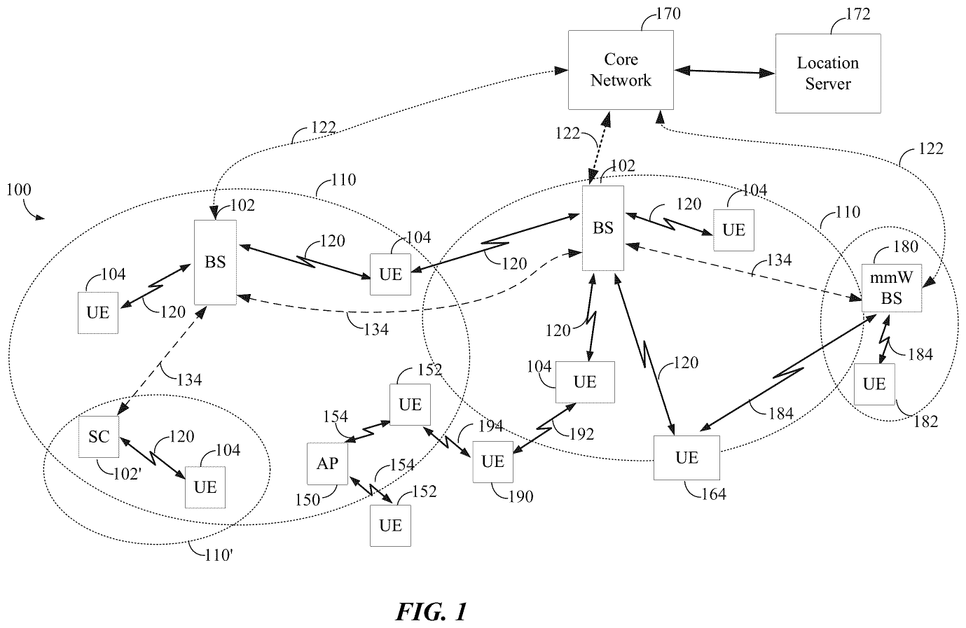

FIG. 1 illustrates an exemplary wireless communications system 100. The wireless communications system 100 (which may also be referred to as a wireless wide area network (WWAN)) may include various base stations 102 and various UEs 104. The base stations 102 may include macro cell base stations (high power cellular base stations) and/or small cell base stations (low power cellular base stations). In an aspect, the macro cell base station may include eNBs where the wireless communications system 100 corresponds to an LTE network, or gNBs where the wireless communications system 100 corresponds to a 5G network, or a combination of both, and the small cell base stations may include femtocells, picocells, microcells, etc.

The base stations 102 may collectively form a RAN and interface with a core network 170 (e.g., an evolved packet core (EPC) or next generation core (NGC)) through backhaul links 122, and through the core network 170 to one or more location servers 172. In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/NGC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCID), a virtual cell identifier (VCID)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include UL (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to DL and UL (e.g., more or less carriers may be allocated for DL than for UL).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or 5G technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. LTE in an unlicensed spectrum may be referred to as LTE-unlicensed (LTE-U), licensed assisted access (LAA), or MulteFire.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

In 5G, the frequency spectrum in which wireless nodes (e.g., base stations 102/180, UEs 104/182) operate is divided into multiple frequency ranges, FR1 (from 450 to 6000 MHz), FR2 (from 24250 to 52600 MHz), FR3 (above 52600 MHz), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels. A secondary carrier is a carrier operating on a second frequency (e.g., FR2) that may be configured once the RRC connection is established between the UE 104 and the anchor carrier and that may be used to provide additional radio resources. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include one or more UEs, such as UE 190, that connects indirectly to one or more communication networks via one or more device-to-device (D2D) peer-to-peer (P2P) links. In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth®, and so on.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

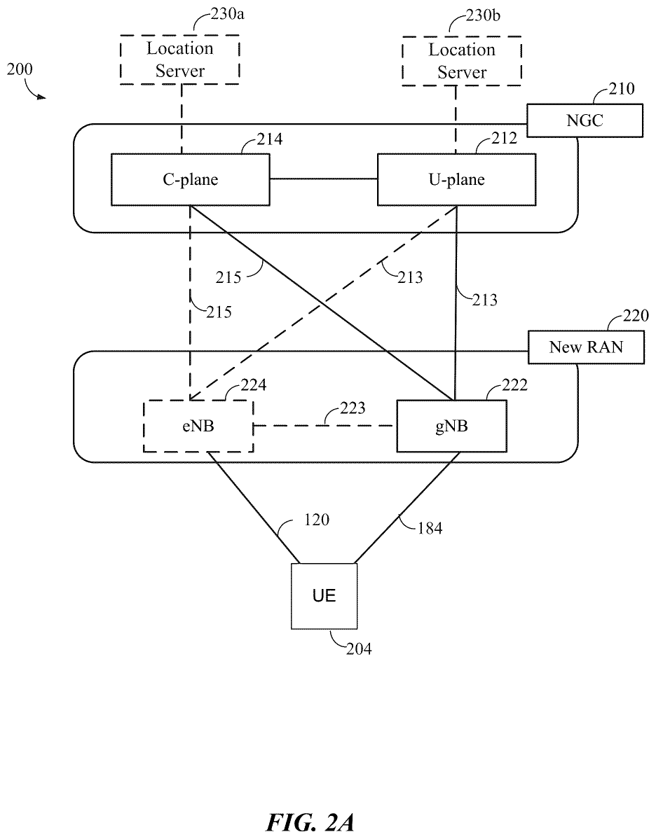

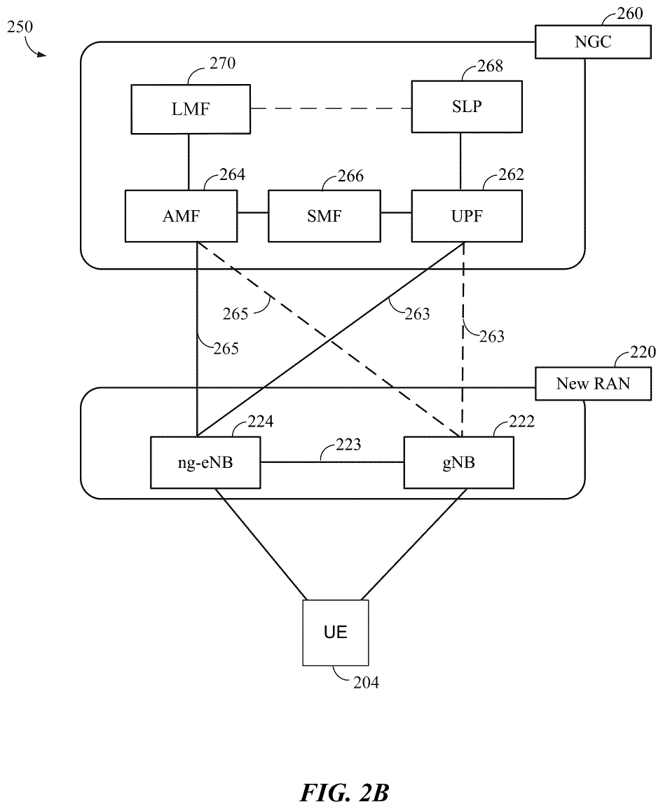

FIG. 2A illustrates an example wireless network structure 200. For example, an NGC 210 (also referred to as a “5GC”) can be viewed functionally as control plane functions 214 (e.g., UE registration, authentication, network access, gateway selection, etc.) and user plane functions 212, (e.g., UE gateway function, access to data networks, IP routing, etc.) which operate cooperatively to form the core network. User plane interface (NG-U) 213 and control plane interface (NG-C) 215 connect the gNB 222 to the NGC 210 and specifically to the control plane functions 214 and user plane functions 212. In an additional configuration, an eNB 224 may also be connected to the NGC 210 via NG-C 215 to the control plane functions 214 and NG-U 213 to user plane functions 212. Further, eNB 224 may directly communicate with gNB 222 via a backhaul connection 223. In some configurations, the New RAN 220 may only have one or more gNBs 222, while other configurations include one or more of both eNBs 224 and gNBs 222. Either gNB 222 or eNB 224 may communicate with UEs 204 (e.g., any of the UEs depicted in FIG. 1). Another optional aspect may include one or more location servers 230a, 230b (sometimes collectively referred to as location server 230) (which may correspond to location server 172), which may be in communication with the control plane functions 214 and user plane functions 212, respectively, in the NGC 210 to provide location assistance for UEs 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, NGC 210, and/or via the Internet (not illustrated). Further, the location server 230 may be integrated into a component of the core network, or alternatively may be external to the core network, e.g., in the New RAN 220.

FIG. 2B illustrates another example wireless network structure 250. For example, an NGC 260 (also referred to as a “5GC”) can be viewed functionally as control plane functions, provided by an access and mobility management function (AMF) 264, user plane function (UPF) 262, a session management function (SMF) 266, SLP 268, and an LMF 270, which operate cooperatively to form the core network (i.e., NGC 260). User plane interface 263 and control plane interface 265 connect the ng-eNB 224 to the NGC 260 and specifically to UPF 262 and AMF 264, respectively. In an additional configuration, a gNB 222 may also be connected to the NGC 260 via control plane interface 265 to AMF 264 and user plane interface 263 to UPF 262. Further, eNB 224 may directly communicate with gNB 222 via the backhaul connection 223, with or without gNB direct connectivity to the NGC 260. In some configurations, the New RAN 220 may only have one or more gNBs 222, while other configurations include one or more of both ng-eNBs 224 and gNBs 222. Either gNB 222 or eNB 224 may communicate with UEs 204 (e.g., any of the UEs depicted in FIG. 1). The base stations of the New RAN 220 communicate with the AMF 264 over the N2 interface and the UPF 262 over the N3 interface.

The functions of the AMF include registration management, connection management, reachability management, mobility management, lawful interception, transport for session management (SM) messages between the UE 204 and the SMF 266, transparent proxy services for routing SM messages, access authentication and access authorization, transport for short message service (SMS) messages between the UE 204 and the short message service function (SMSF) (not shown), and security anchor functionality (SEAF). The AMF also interacts with the authentication server function (AUSF) (not shown) and the UE 204 and receives the intermediate key that was established as a result of the UE 204 authentication process. In the case of authentication based on a UMTS (universal mobile telecommunications system) subscriber identity module (USIM), the AMF retrieves the security material from the AUSF. The functions of the AMF also include security context management (SCM). The SCM receives a key from the SEAF that it uses to derive access-network specific keys. The functionality of the AMF also includes location services management for regulatory services, transport for location services messages between the UE 204 and the location management function (LMF) 270 (which may correspond to location server 172), as well as between the New RAN 220 and the LMF 270, evolved packet system (EPS) bearer identifier allocation for interworking with the EPS, and UE 204 mobility event notification. In addition, the AMF also supports functionalities for non-Third Generation Partnership Project (3GPP) access networks.

Functions of the UPF include acting as an anchor point for intra-/inter-RAT mobility (when applicable), acting as an external protocol data unit (PDU) session point of interconnect to the data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., UL/DL rate enforcement, reflective QoS marking in the DL), UL traffic verification (service data flow (SDF) to QoS flow mapping), transport level packet marking in the UL and DL, DL packet buffering and DL data notification triggering, and sending and forwarding of one or more “end markers” to the source RAN node.

The functions of the SMF 266 include session management, UE Internet protocol (IP) address allocation and management, selection and control of user plane functions, configuration of traffic steering at the UPF to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the NGC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, NGC 260, and/or via the Internet (not illustrated).

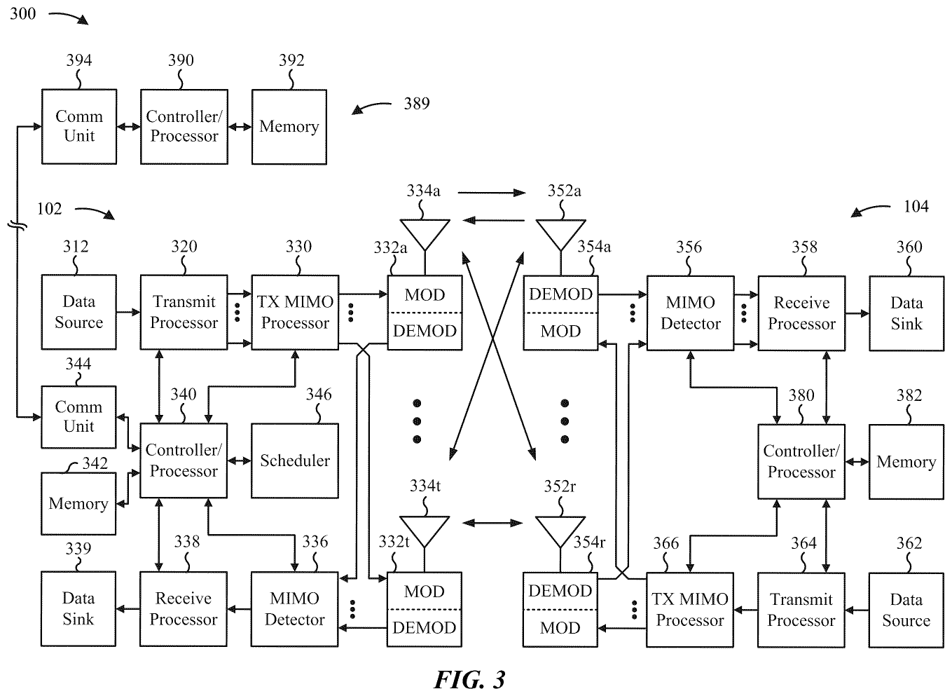

FIG. 3 shows a block diagram of a design 300 of base station 102 and UE 104, which may be one of the base stations and one of the UEs in FIG. 1. Base station 102 may be equipped with T antennas 334a through 334t, and UE 104 may be equipped with R antennas 352a through 352r, where in general T≥1 and R≥1.

At base station 102, a transmit processor 320 may receive data from a data source 312 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 320 may also process system information (e.g., for semi-static resource partitioning information (SRPI) and/or the like) and control information (e.g., CQI requests, grants, upper layer signaling, and/or the like) and provide overhead symbols and control symbols. Transmit processor 320 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 330 may perform spatial processing (e.g., precoding) on the data symbols, the control symbols, the overhead symbols, and/or the reference symbols, if applicable, and may provide T output symbol streams to T modulators (MODs) 332a through 332t. Each modulator 332 may process a respective output symbol stream (e.g., for OFDM and/or the like) to obtain an output sample stream. Each modulator 332 may further process (e.g., convert to analog, amplify, filter, and upconvert) the output sample stream to obtain a downlink signal. T downlink signals from modulators 332a through 332t may be transmitted via T antennas 334a through 334t, respectively. According to various aspects described in more detail below, the synchronization signals can be generated with location encoding to convey additional information.

At UE 104, antennas 352a through 352r may receive the downlink signals from base station 102 and/or other base stations and may provide received signals to demodulators (DEMODs) 354a through 354r, respectively. Each demodulator 354 may condition (e.g., filter, amplify, down convert, and digitize) a received signal to obtain input samples. Each demodulator 354 may further process the input samples (e.g., for OFDM and/or the like) to obtain received symbols. A MIMO detector 356 may obtain received symbols from all R demodulators 354a through 354r, perform MIMO detection on the received symbols if applicable, and provide detected symbols. A receive processor 358 may process (e.g., demodulate and decode) the detected symbols, provide decoded data for UE 104 to a data sink 360, and provide decoded control information and system information to a controller/processor 380. A channel processor may determine reference signal received power (RSRP), received signal strength indicator (RSSI), reference signal received quality (RSRQ), channel quality indicator (CQI), and/or the like. In some aspects, one or more components of UE 104 may be included in a housing.

On the uplink, at UE 104, a transmit processor 364 may receive and process data from a data source 362 and control information (e.g., for reports comprising RSRP, RSSI, RSRQ, CQI, and/or the like) from controller/processor 380. Transmit processor 364 may also generate reference symbols for one or more reference signals. The symbols from transmit processor 364 may be precoded by a TX MIMO processor 366 if applicable, further processed by modulators 354a through 354r (e.g., for DFT-s-OFDM, CP-OFDM, and/or the like), and transmitted to base station 102. At base station 102, the uplink signals from UE 104 and other UEs may be received by antennas 334, processed by demodulators 332, detected by a MIMO detector 336 if applicable, and further processed by a receive processor 338 to obtain decoded data and control information sent by UE 104. Receive processor 338 may provide the decoded data to a data sink 339 and the decoded control information to controller/processor 340. Base station 102 may include communication unit 344 and communicate to network controller 389 via communication unit 344. Network controller 389 may include communication unit 394, controller/processor 390, and memory 392.

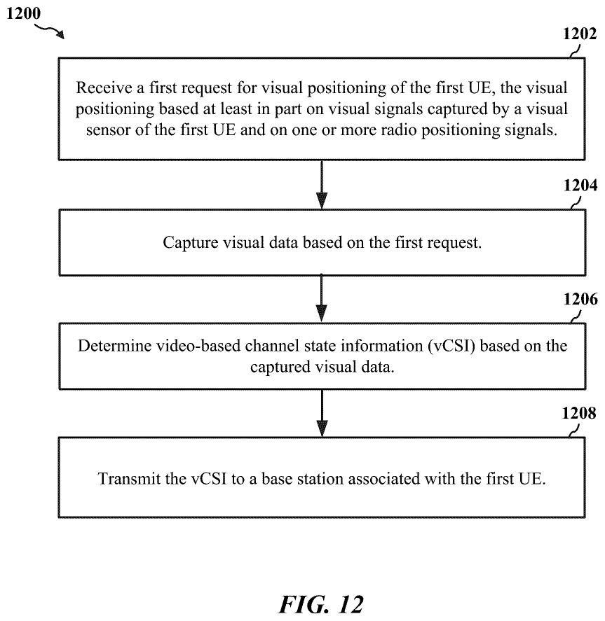

Controller/processor 340 of base station 102, controller/processor 380 of UE 104, controller 390 of network controller 389, which may be location server 172, and/or any other component(s) of FIG. 3 may perform one or more techniques supporting positioning of the UE using relative location information messages, as described in more detail elsewhere herein. For example, controller/processor 380 of UE 104, controller 390 of network controller 389, controller/processor 340 of base station 102, and/or any other component(s) of FIG. 3 may perform or direct operations of, for example, processes 1200, 1300, and 1400 of FIGS. 12, 13, and 14, and/or other processes as described herein. Memories 342, 382, and 392 may store data and program codes for base station 102, UE 104, and network controller 389, respectively. In some aspects, memory 342 and/or memory 382 and/or memory 392 may comprise a non-transitory computer-readable medium storing one or more instructions for wireless communication. For example, the one or more instructions, when executed by one or more processors of the UE 104, network controller 389, and/or base station 102, may perform or direct operations of, for example, processes 1200, 1300, and 1400 of FIGS. 12, 13, and 14 and/or other processes as described herein. A scheduler 346 may schedule UEs for data transmission on the downlink and/or uplink.

As indicated above, FIG. 3 is provided as an example. Other examples may differ from what is described with regard to FIG. 3.

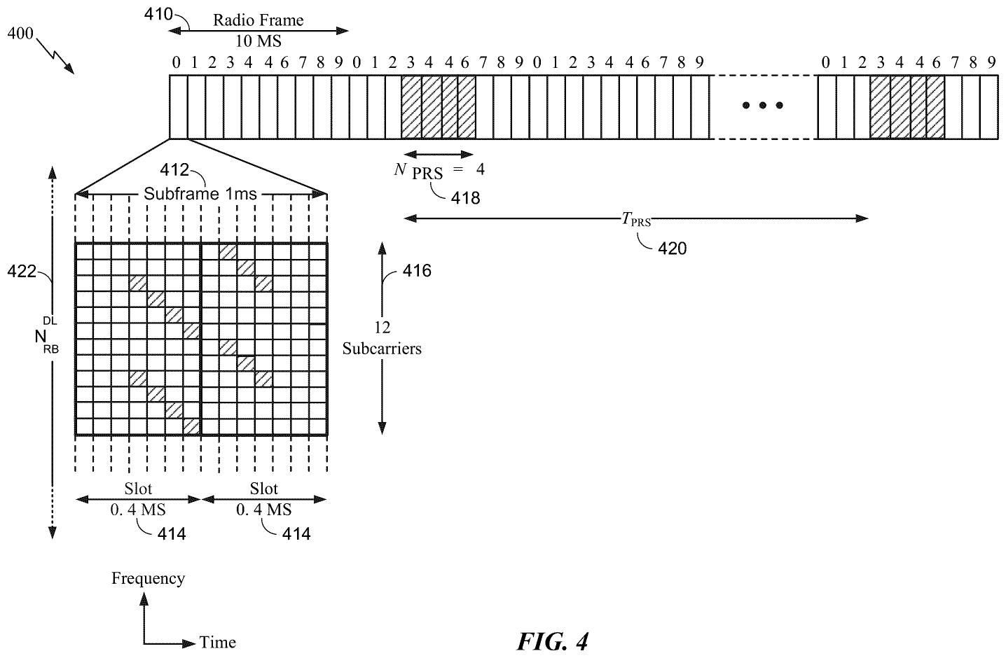

FIG. 4 shows a structure of an exemplary subframe sequence 400 with positioning reference signal (PRS) positioning occasions, according to aspects of the disclosure. Subframe sequence 400 may be applicable to the broadcast of PRS signals from a base station (e.g., any of the base stations described herein) or other network node. The subframe sequence 400 may be used in LTE systems, and the same or similar subframe sequence may be used in other communication technologies/protocols, such as 5G and NR. In FIG. 4, time is represented horizontally (e.g., on the X axis) with time increasing from left to right, while frequency is represented vertically (e.g., on the Y axis) with frequency increasing (or decreasing) from bottom to top. As shown in FIG. 4, downlink and uplink radio frames 410 may be of 10 millisecond (ms) duration each. For downlink frequency division duplex (FDD) mode, radio frames 410 are organized, in the illustrated example, into ten subframes 412 of 1 ms duration each. Each subframe 412 comprises two slots 414, each of, for example, 0.5 ms duration.

In the frequency domain, the available bandwidth may be divided into uniformly spaced orthogonal subcarriers 416 (also referred to as “tones” or “bins”). For example, for a normal length cyclic prefix (CP) using, for example, 15 kHz spacing, subcarriers 416 may be grouped into a group of twelve (12) subcarriers. A resource of one OFDM symbol length in the time domain and one subcarrier in the frequency domain (represented as a block of subframe 412) is referred to as a resource element (RE). Each grouping of the 12 subcarriers 416 and the 14 OFDM symbols is termed a resource block (RB) and, in the example above, the number of subcarriers in the resource block may be written as N_{sc}^{RB}=12. For a given channel bandwidth, the number of available resource blocks on each channel 422, which is also called the transmission bandwidth configuration 422, is indicated as N_{RB}^{DL}. For example, for a 3 MHz channel bandwidth in the above example, the number of available resource blocks on each channel 422 is given by N=15. Note that the frequency component of a resource block (e.g., the 12 subcarriers) is referred to as a physical resource block (PRB).

A base station may transmit radio frames (e.g., radio frames 410), or other physical layer signaling sequences, supporting PRS signals (i.e. a downlink (DL) PRS) according to frame configurations either similar to, or the same as that, shown in FIG. 4, which may be measured and used for a UE (e.g., any of the UEs described herein) position estimation. Other types of wireless nodes (e.g., a distributed antenna system (DAS), remote radio head (RRH), UE, AP, etc.) in a wireless communications network may also be configured to transmit PRS signals configured in a manner similar to (or the same as) that depicted in FIG. 4.

A collection of resource elements that are used for transmission of PRS signals is referred to as a “PRS resource.” The collection of resource elements can span multiple PRBs in the frequency domain and N (e.g., 1 or more) consecutive symbol(s) within a slot 414 in the time domain. For example, the cross-hatched resource elements in the slots 414 may be examples of two PRS resources. A “PRS resource set” is a set of PRS resources used for the transmission of PRS signals, where each PRS resource has a PRS resource identifier (ID). In addition, the PRS resources in a PRS resource set are associated with the same transmission-reception point (TRP). A PRS resource ID in a PRS resource set is associated with a single beam transmitted from a single TRP (where a TRP may transmit one or more beams). Note that this does not have any implications on whether the TRPs and beams from which signals are transmitted are known to the UE.

PRS may be transmitted in special positioning subframes that are grouped into positioning occasions. A PRS occasion is one instance of a periodically repeated time window (e.g., consecutive slot(s)) where PRS are expected to be transmitted. Each periodically repeated time window can include a group of one or more consecutive PRS occasions. Each PRS occasion can comprise a number N_{PRS} of consecutive positioning subframes. The PRS positioning occasions for a cell supported by a base station may occur periodically at intervals, denoted by a number T_{PRS} of milliseconds or subframes. As an example, FIG. 4 illustrates a periodicity of positioning occasions where N_{PRS} equals 4 418 and T_{PRS} is greater than or equal to 20 420. In some aspects, T_{PRS} may be measured in terms of the number of subframes between the start of consecutive positioning occasions. Multiple PRS occasions may be associated with the same PRS resource configuration, in which case, each such occasion is referred to as an “occasion of the PRS resource” or the like.

A PRS may be transmitted with a constant power. A PRS can also be transmitted with zero power (i.e., muted). Muting, which turns off a regularly scheduled PRS transmission, may be useful when PRS signals between different cells overlap by occurring at the same or almost the same time. In this case, the PRS signals from some cells may be muted while PRS signals from other cells are transmitted (e.g., at a constant power). Muting may aid signal acquisition and time of arrival (TOA) and reference signal time difference (RSTD) measurement, by UEs, of PRS signals that are not muted (by avoiding interference from PRS signals that have been muted). Muting may be viewed as the non-transmission of a PRS for a given positioning occasion for a particular cell. Muting patterns (also referred to as muting sequences) may be signaled (e.g., using the LTE positioning protocol (LPP)) to a UE using bit strings. For example, in a bit string signaled to indicate a muting pattern, if a bit at position j is set to ‘0’, then the UE may infer that the PRS is muted for a j^{th} positioning occasion.

To further improve hearability of PRS, positioning subframes may be low-interference subframes that are transmitted without user data channels. As a result, in ideally synchronized networks, PRS may be interfered with by other cells' PRS with the same PRS pattern index (i.e., with the same frequency shift), but not from data transmissions. The frequency shift may be defined as a function of a PRS ID for a cell or other transmission point (TP) (denoted as N_{ID}^{PRS}) or as a function of a physical cell identifier (PCI) (denoted as N_{ID}^{cell}) if no PRS ID is assigned, which results in an effective frequency re-use factor of six (6).

To also improve hearability of a PRS (e.g., when PRS bandwidth is limited, such as with only six resource blocks corresponding to 1.4 MHz bandwidth), the frequency band for consecutive PRS positioning occasions (or consecutive PRS subframes) may be changed in a known and predictable manner via frequency hopping. In addition, a cell supported by a base station may support more than one PRS configuration, where each PRS configuration may comprise a distinct frequency offset (vshift), a distinct carrier frequency, a distinct bandwidth, a distinct code sequence, and/or a distinct sequence of PRS positioning occasions with a particular number of subframes (N_{PRS}) per positioning occasion and a particular periodicity (T_{PRS}). In some implementation, one or more of the PRS configurations supported in a cell may be for a directional PRS and may then have additional distinct characteristics, such as a distinct direction of transmission, a distinct range of horizontal angles, and/or a distinct range of vertical angles.

A PRS configuration, as described above, including the PRS transmission/muting schedule, is signaled to the UE to enable the UE to perform PRS positioning measurements. The UE is not expected to blindly perform detection of PRS configurations.

Note that the terms “positioning reference signal” and “PRS” may sometimes refer to specific reference signals that are used for positioning in LTE/NR systems. However, as used herein, unless otherwise indicated, the terms “positioning reference signal” and “PRS” refer to any type of reference signal that is intended for positioning. Downlink (DL) or sidelink (SL) signals for which the primary purpose is unrelated to positioning, such as control or communication, are referred to herein as non-positioning reference signals (non-PRS). Examples of non-PRS include, but are not limited to, PHY channels, such as SSB, TRS, CSI-RS, PDSCH, DM-RS, PDCCH, PSSCH, and PSCCH.

As discussed above, in some UE based positioning modes, a UE may receive assistance data and determine a location estimate based at least in part on the resulting location measurements. For example, a location management function (LMF) may configure the UE with a PRS resources ID for measurements, may provide location information for one or more TRPs, may provide satellite ephemeris data in the case of GPS or GNSS, and so on. In some other UE based positioning modes the UE may make location related measurements without any positioning assistance data from a location server and may further compute a location or a change in location without any positioning assistance. Recent 3GPP releases allow for a UE to report its position fix in a variety of manners, such as a single position fix, as well as periodically, or when triggered by one or more events.

In addition, many UEs include cameras capable of capturing visual data such as images and/or video, and such visual data may be used to determine characteristics of a UE's environs. Such visual data may be used for detecting and characterizing environments and objects captured in such visual data, and so on. For example, objects in captured video may be categorized as moving or nonmoving, human or nonhuman, and so on. Similarly the environment of captured visual data may be categorized as indoors or outdoors, the approximate size of indoor spaces may be estimated, and so on. Visual data may be captured, and converted into video-based channel state information, or vCSI, which may be reported to a gNodeB, or a location server coupled to the UE.

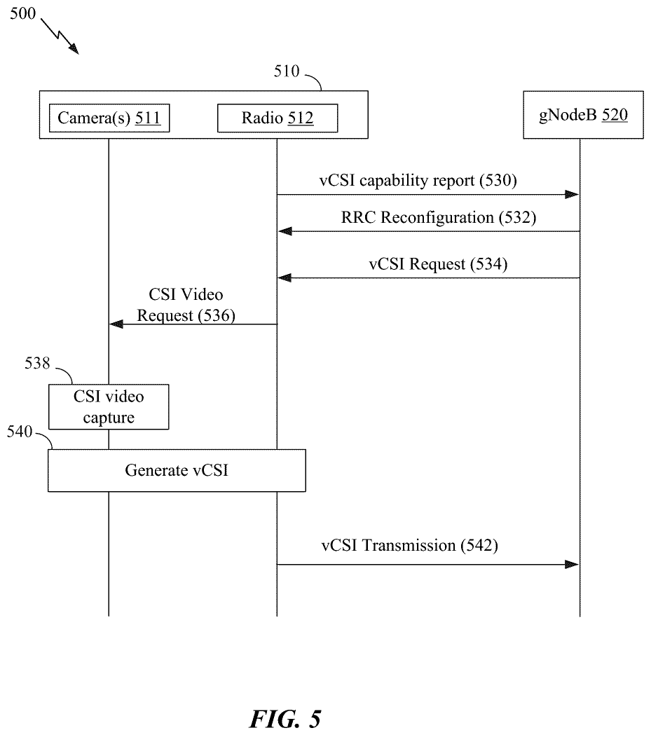

FIG. 5 shows a time sequence diagram 500 depicting a UE generating and reporting vCSI based on captured visual data. The time sequence diagram 500 shows messages exchanged between a UE 510 and a gNodeB 520. The UE 510 may include at least one or more cameras 511 for capturing visual data such as images and/or video and a radio unit or transceiver 512. Radio 512 may be any suitable type of radio or transceiver, such as a WWAN transceiver, a short-range transceiver, a GNSS receiver, and so on, and may communicate according to any suitable wireless communication protocol, such as a 4G, 5G, a WiFi communication protocol, an ultrawideband (UWB) communication protocol, a Bluetooth communication protocol, a GNSS communication protocol, and so on. The UE 510 may transmit and receive wireless signals to and from the gNodeB 520 using the radio 512. A radio resource control (RRC) connection setup may be performed between the UE 510 and the gNodeB 520. This RRC connection setup is omitted from FIG. 5 for simplicity. After RRC connection, the UE 510 may report (530) its capabilities for generating vCSI to the gNodeB 520. For example, the UE 510 may report information such as a number of cameras 511, power or battery constraints of the UE 510 or the cameras 511, capabilities for tuning the direction(s) the cameras 511 face while capturing visual data for generating vCSI, and so on. After reporting the vCSI capabilities, the UE 510 may receive (532) RRC reconfiguration information from the gNodeB 520. Such RRC reconfiguration information may include configuration information for generating the vCSI, such as a codebook associated with the vCSI, a machine learning (ML) model configured for generating the vCSI based on visual data captured by the UE 510, and so on. The gNodeB may then request (534) the UE 510 to generate and report vCSI information according to the parameters specified in the RRC reconfiguration. In some cases this request may be express, implicit, event-triggered, and so on. The UE 510 may instruct or request (536) the cameras 511 to capture visual data for generating the requested vCSI according to the parameters specified in the RRC reconfiguration. For example, one or more processors associated with the radio 512 may configure the cameras 511, such as via a camera controller associated with the cameras 511, to capture the visual data. This request may be called a CSI Video request. In response, the cameras 511 may capture visual data for generating the vCSI, such as capturing images and/or video for generating the vCSI. Capturing this visual data may be called a CSI video capture 538. The vCSI may be generated (540) from the captured CSI video based on the RRC reconfiguration, that is, according to the parameters indicated in the RRC reconfiguration, such as the codebook, the ML model, and so on. The generated vCSI may be compressed or abstracted, for example according to the parameters indicated in the RRC reconfiguration. The compressed or abstracted vCSI may then be transmitted (542) to the gNodeB 520, for example via a physical uplink shared channel (PUSCH) or a physical uplink control channel (PUCCH), and the gNodeB 520 may send the vCSI to a location server associated with the GNodeB 520 (not shown in FIG. 5 for simplicity). Subsequent UL and/or DL transmissions for the UE 510 may then be scheduled based at least in part on the vCSI.

Because captured visual data and vCSI may include helpful information about the location and environment where a UE is located, this information may also be helpful for positioning. It would therefore be desirable to combine vCSI with other radio-based positioning techniques to improve positioning of a UE.

Accordingly, aspects of the example implementations allow for positioning of a UE to be based on both radio-based positioning techniques (e.g., NR, LTE, GPS, GNSS, and so on) and vCSI generated by the UE. For example, vCSI may provide additional context for and augment radio-based positioning techniques. Similarly, radio-based positioning techniques may inform and augment subsequently generated vCSI. In both cases, positioning of a UE may be significantly improved as compared with radio-based positioning or vCSI alone. For example, radio positioning may inform subsequent vCSI determinations by identifying a presence, a distance, or an angle at which another wireless device is located, and the subsequent vCSI may thereby result in better positioning information about the UE. Similarly, the UE may generate vCSI, which may indicate the presence, distance, and angle of another wireless device, in order to inform subsequent radio-based positioning. The radio-based positioning and vCSI may also be used in combination to better characterize a location of the UE in the absence of the presence of other wireless devices. For example, the position of the UE may be estimated using radio-based techniques, and then the UE may be provided with mapping or landmark information based on the estimated position. For example, the UE may be provided with a collection of one or more points of interest. Subsequently generated vCSI may be informed by these points of interest and may better inform the position of the UE.

Use of vCSI in combination and coordination with radio-based positioning may be particularly helpful when UEs are located in environments subject to multipath, such as indoor environments. For example, a first UE may be located within a house, and 5G or GPS positioning accuracy may be significantly limited by multipath. The approximate position of the first UE indicated by the 5G or GPS positioning may be augmented by sidelink positioning with one or more wireless devices, in addition to visual-based positioning using vCSI in order to estimate the position of the first UE more accurately.

Further, the vCSI determined using example techniques may be provided in a tag-based format, where tags are applied to data associated with objects or devices in the video data captured by a UE or the vCSI generated by the UE. For example, such tags may characterize environments in captured visual data as being indoors or outdoors. Similarly, the video frames captured in the visual data may be segmented using MEL and characterized. For example, such characterization may characterize a frame as including a human, as including the sky, and various outdoor or indoor surfaces such as walls, grass, carpeting, hard floors, and so on. Further properties of a zone may be applied to the captured visual data and reflected in the generated vCSI, such as reflections, blockages, a size of a room within the visual data is captured, and so on.

In accordance with some implementations, radio-based positioning and vCSI may be used in coordination to detect and locate other wireless devices within visual range of a UE. Prior to such positioning, a first UE may report its vCSI capabilities to a location server, or a gNodeB or AP. Such capabilities may include information such as a number of cameras associated with the first UE, a camera type associated with those cameras, one or more zoom or focus capabilities associated with the cameras, one or more movement capabilities associated with the cameras, and so on.

The location server, GNodeB, or AP may send a location request to the first UE to determine vCSI associated with one or more wireless devices determined to be in a vicinity of the first UE. This vCSI may be associated with visual sensor-based positioning of the one or more wireless devices. In some aspects, this location request may include an expected direction at which the first UE should direct its cameras. In some aspects, this direction may be an angle or a range of angles in two- or three-dimensional space. The location request may also include a distance at which the first UE should focus its cameras. The location request may also include a threshold of detection associated with the vCSI, and a periodicity at which the vCSI should be reported. The location request may further indicate one or more categories of object of interest. Such categories may include human objects as compared with nonhuman objects, a size of object, a motion status of object, one or more environmental classifications such as indoor vs. outdoor, and so on. The category of object of interest may include a subset of objects of interest. For example, the subset may include humans, pets, and moving objects, but not stationary nonliving objects. The location request may further indicate a radius of detection associated with the vCSI. The location request may further indicate one or more aspects of the ML model used for generating the vCSI, such as a latency requirement associated with the ML model, a parameterization or another configuration associated with the ML model.

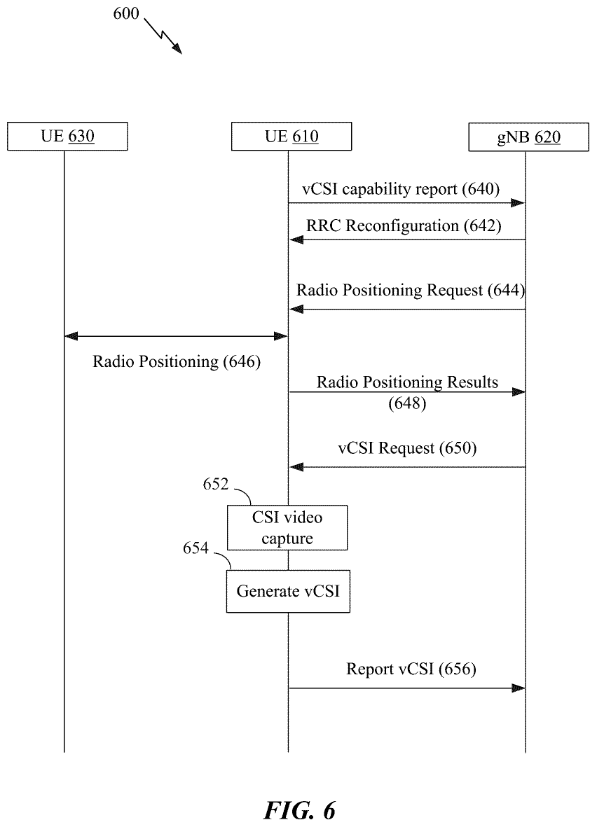

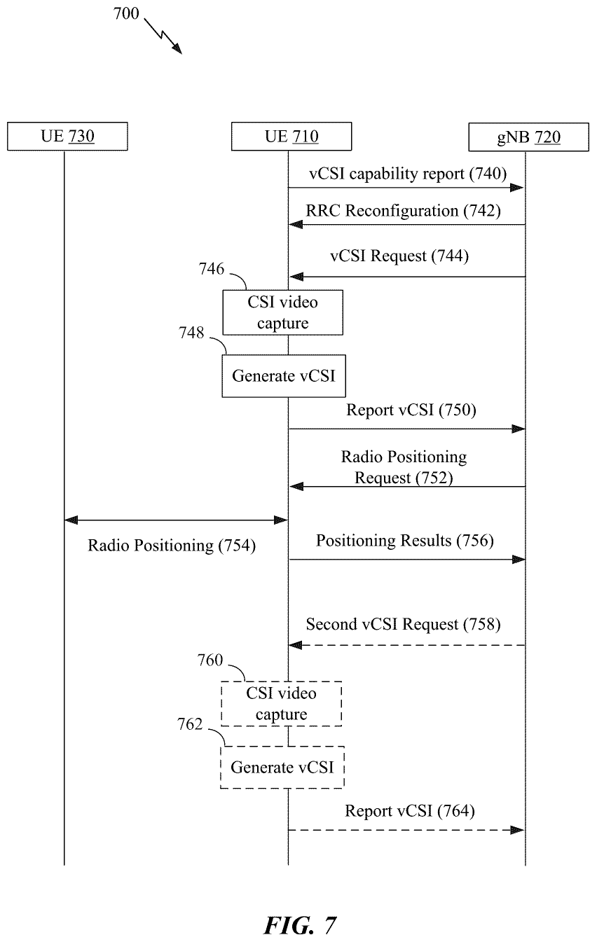

In some aspects, the direction and distance associated with the location request may be based on one or more radio-based positioning measurements between the first UE and another wireless device, such as a second UE. In some implementations the one or more radio-based positioning measurements may be determined using sidelink positioning between the first UE and the second UE. For example, the first UE may receive two location requests, one for radio-based positioning, and another for vCSI based positioning. In some aspects these requests may be received sequentially, as described below with respect to FIGS. 6-7, while in some other aspects a joint location request may correspond to both the radio- and to the vCSI-based positioning. In some aspects, the radio-based positioning may occur first, while in some other aspects, vCSI-based positioning may occur first.

FIG. 6 shows an example time sequence diagram 600 for radio-positioning assisted vCSI determination, according to some implementations. FIG. 6 shows an example implementation where the radio-based positioning occurs prior to the vCSI-based positioning. A UE 610 may report (640) its vCSI capabilities to a gNB 620. As discussed above, such capabilities may include information such as a number of cameras associated with the first UE, a camera type associated with those cameras, one or more zoom or focus capabilities associated with the cameras, one or more movement capabilities associated with the cameras, and so on. Additionally, RRC Reconfiguration (642) may provide the UE 610 with configuration information for generating vCSI, such as a codebook associated with the vCSI, a machine learning (ML) model configured for generating the vCSI based on visual data captured by the UE 610, and so on.

The UE 610 receives (644) a radio positioning request from gNB 620, to exchange radio positioning signals with a UE 630 in order to determine the position of the UE 620 with respect to the UE 610. For example, the radio positioning request may originate with the gNB 620 or may originate at a location server coupled to the gNB via one or more networks. The UE 610 may then exchange one or more radio positioning signals with the UE 630. For example, the radio positioning 646 may generate one or more positioning measurements, such as a distance between the UE 610 and the UE 630 and an angle of arrival or angle of departure of signals exchanged between the UE 610 and the UE 630. For example, the radio positioning signals may be associated with GNSS, Time Difference of Arrival (TDOA), Angle of Departure (AoD), Round Trip Time (RTT) or multi cell RTT (Multi-RTT), and/or Enhanced Cell ID (ECID) position methods for determining the distance and angle between the UE 610 and the UE 630. The results of the radio positioning may be transmitted (648) to the gNB 620 and the location server (not shown for simplicity).

The gNB 620 may then transmit (650) a vCSI-based positioning request to the UE 610 (“vCSI request”). In some aspects, this vCSI-based positioning request may be sent from a location server associated with the UE 610 and the gNB 620. The vCSI request is based at least in part on the results of the radio positioning. For example, an angle indicated by the radio positioning results may be indicated in the vCSI request, indicating an angle at which the UE 610 should point its cameras in order to capture visual data about the UE 630. The vCSI request may also indicate a distance to the UE 630 as determined using the ratio positioning results. Thus, the results of the radio positioning between the UE 610 and the UE 630 may inform and provide context for improving the accuracy of the vCSI captured in response to the vCSI request. That is, the results of the radio positioning may improve the accuracy and relevancy of the captured vCSI by providing a more accurate estimate of the position of the UE 630 with respect to the UE 610. Thus, in some aspects, the direction for capturing the vCSI may be specified with a greater degree of confidence, may be specified more particularity, or the direction may include a smaller range of angles of interest due to the results of the radio-based positioning.

The UE 610 may capture (652) CSI video based on the information included in the vCSI request, such as capturing the CSI video while the cameras of the UE 610 are pointed in the direction indicated in the vCSI request. The UE 610 may then generate and compress the captured CSI video (654) according to the configuration information indicated in the RRC reconfiguration. The compressed vCSI is then reported (656) to the gNB 620 and the location server.

In some other aspects, rather than the radio positioning preceding and informing subsequently generated vCSI, vCSI may be generated first, and used to inform subsequent radio positioning. FIG. 7 shows an example time sequence diagram 700 for radio-positioning assisted vCSI determination, according to some implementations. FIG. 7 shows an example implementation where the radio-based positioning occurs after vCSI-based positioning. A UE 710 may report (740) its vCSI capabilities to a gNB 720. As discussed above, such capabilities may include information such as a number of cameras associated with the first UE, a camera type associated with those cameras, one or more zoom or focus capabilities associated with the cameras, one or more movement capabilities associated with the cameras, and so on. Additionally, RRC Reconfiguration (742) may provide the UE 710 with configuration information for generating vCSI, such as a codebook associated with the vCSI, a machine learning (ML) model configured for generating the vCSI based on visual data captured by the UE 710, and so on.

The gNB 720 may then transmit (744) a vCSI-based positioning request to the UE 710 (“vCSI request”). In some aspects, this vCSI-based positioning request may be sent from a location server associated with the UE 710 and the gNB 720. This vCSI-based positioning request may be a request for the UE 710 to determine vCSI for detecting a presence and direction of one or more objects within visible range of the UE 710. For example, the vCSI may detect a presence of the UE 730, of one or more humans or objects of interest within visible range of the UE 710. For example, the vCSI request may indicate a comparatively broad range of angles associated with the vCSI, in order to detect this presence. The UE 710 may capture (746) CSI video based on the information included in the vCSI request, such as capturing the CSI video while the cameras of the UE 710 are pointed in the direction indicated in the vCSI request 744. The UE 710 may then generate and compress the captured CSI video (748) according to the configuration information indicated in the RRC reconfiguration. The compressed vCSI is then reported (750) to the gNB 720 and the location server.

The vCSI transmitted to the gNB 720 and location server may indicate the presence of one or more objects of interest, such as the UE 730. In some aspects, the gNB 720 or the location server may process the vCSI information transmitted by the UE 710 and determine the presence of the UE 730. A radio-based positioning request may then be transmitted (752) to the UE 710, directing the UE 710 to exchange radio positioning signals with the UE 730 in order to more accurately determine the position of the UE 720 with respect to the UE 710. For example, the radio positioning request may originate with the gNB 720 or may originate at the location server. The UE 710 may then exchange one or more radio positioning signals (754) with the UE 730. For example, the radio positioning 754 may generate one or more positioning measurements, such as a distance between the UE 710 and the UE 730 and an angle of arrival or angle of departure of signals exchanged between the UE 710 and the UE 730. For example, the radio positioning measurements may be associated with GNSS, Time Difference of Arrival (TDOA), Angle of Departure (AoD), Round Trip Time (RTT) or multi cell RTT (Multi-RTT), and/or Enhanced Cell ID (ECID) position methods for determining the distance and angle between the UE 710 and the UE 730. The results of the radio positioning may be transmitted (756) to the gNB 720 and the location server. Thus, the vCSI may inform the subsequent radio-based positioning by indicating the presence of the UE 730 or other objects or devices of interest visible to the UE 710. For example, if the vCSI does not indicate the presence of the UE 730, then the subsequent radio positioning may not occur, saving airtime and power associated with the radio-based positioning. When the UE 730's presence is detected based on the vCSI, then the subsequent radio-based positioning may be more accurately performed. For example, the vCSI may indicate not only the presence of the UE 730, but a direct line of sight between the UE 710 and the UE 730. This may provide additional reliability of the radio-based positioning, by ruling out reflections and multipath issues associated with received radio positioning signals.

In some aspects, a second vCSI request may be transmitted (758) from the gNB 720 to the UE 710 after the radio-based positioning. The second vCSI request may be based at least in part on the results of the radio positioning. For example, similarly to the example of FIG. 6, an angle indicated by the radio positioning results may be indicated in the second vCSI request, indicating an angle at which the UE 710 should point its cameras in order to capture visual data about the UE 730. The second vCSI request may also indicate a distance to the UE 730 as determined using the ratio positioning results. Thus, the results of the radio positioning between the UE 710 and the UE 730 may further inform and provide additional context for improving the accuracy of the vCSI captured in response to the second vCSI request. In some aspects, the second vCSI request may be sent immediately following completion of the radio-based positioning, while in some other aspects, the second vCSI request may be transmitted to the UE 710 periodically or may be triggered by to one or more events. The UE 710 may capture (760) CSI video based on the information included in the second vCSI request, such as capturing the CSI video while the cameras of the UE 710 are pointed in the direction indicated in the second vCSI request. The UE 710 may then generate and compress the captured CSI video (762) according to the configuration information indicated in the RRC reconfiguration. The compressed vCSI is then reported (764) to the gNB 720 and the location server.

In the examples described with respect to FIGS. 6 and 7 a first UE may improve its estimated positioning of another wireless device through radio-based positioning and vCSI. That is, the other wireless device is visible to the first UE, and vCSI may be used in combination with the radio-positioning to improve location estimates of the other wireless device. In some other aspects, another wireless device may not be visible to the first UE, and vCSI may also be used in conjunction with radio-based positioning to improve location estimates of the first UE. For example, a gNB or a location server may perform radio-based positioning of the first UE, for example using NR, LTE, GPS/GNSS, or similar. However, this radio-based position estimate for the first UE may only be approximate. For example, a GPS position of the first UE could place the first UE within a building, but multipath issues may prevent more precise location estimation. Further, such radio-based positioning may not allow for characterization of the environment within which the first UE is located. Characterization of the first UE's environs may improve communication with and positioning of the first UE. For example, characterizing whether the first UE is indoors or outdoors, the size of a room within which the UE is located, the proximity of the first UE to the ground, and so on may be important for communicating with the first UE. This radio-positioning assisted vCSI positioning may be useful, for example, in asset tracking applications, where accurate location tracking of a device is desired, but GPS, GNSS, LTE, or other positioning is not sufficiently accurate. The location server may include mapping information for a plurality of points of interest, which may be used to aid vCSI positioning of the first UE. That is, an approximate position of the first UE may be generated using radio positioning, and then vCSI, in conjunction with such mapping information, may allow for the location of the first UE to be determined much more accurately than using radio positioning alone.

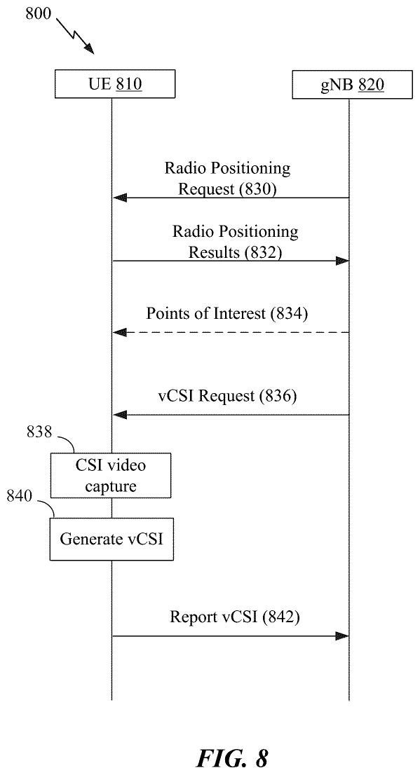

FIG. 8 shows an example time sequence diagram 800 for radio-positioning assisted vCSI determination, according to some implementations. In the example of FIG. 8, no second UE may be present. The UE 810 receives (830) a radio positioning request from gNB 820, to determine the position of the UE 810 based on one or more radio positioning signals exchanged between the UE 810 and the gNB 820. For example, the radio positioning request may originate with the gNB 820 or may originate at a location server coupled to the gNB 820 via one or more networks. The UE 810 may then exchange one or more radio positioning signals with the gNB 820. For example, the radio positioning may generate one or more positioning measurements, such as a distance between the UE 810 and the gNB 820 and an angle of arrival or angle of departure of signals exchanged between the UE 810 and the gNB 820. For example, the radio positioning measurements may be associated with GNSS, Time Difference of Arrival (TDOA), Angle of Departure (AoD), Round Trip Time (RTT) or multi cell RTT (Multi-RTT), and/or Enhanced Cell ID (ECID) position methods for determining the distance and angle between the UE 810 and the gNB 820. In some other aspects, the radio positioning request may be a request for the UE 810 to Results of the radio positioning may be transmitted (832) to the gNB 620 and the location server, which may then estimate the location of the UE 810.

The gNB 820 or the location server may store or be coupled to mapping information, which may for example include a plurality of points of interest, where each point of interest is associated with a location at which the point of interest is located. For example, points of interest may include objects which are capable of being visibly identified through image data captured by a UE, such as the UE 810. For example, in outdoor environments a point of interest may include easily identifiable buildings or landmarks, mountains, the sun, or other objects. For indoor environments, such as for example a factory floor, which may be more common in asset tracking applications, points of interest may include other visibly identifiable features such as signs, windows, or any other fixed and readily visibly identifiable features of the indoor environment.

Based on the estimated location of the UE 810, a subset of the plurality of points of interest may be identified as being potentially visible to the UE 810. The gNB 820 or the location server may transmit (834) this subset of points of interest to the UE 810. The gNB 820 or location server may then transmit (836) a vCSI request to the UE 810. In some aspects, this vCSI request may indicate one or more directions and/or distances based on the subset of points of interest. For example, the vCSI request may indicate a range of directions broad enough to be likely to capture images, and thus vCSI, associated with points of interest of the subset of points of interest. The UE 810 may capture (838) CSI video based on the information included in the vCSI request, such as capturing the CSI video while the cameras of the UE 810 are pointed in the direction indicated in the vCSI request. The UE 810 may then generate and compress the captured CSI video (840) according to the configuration information indicated in the RRC reconfiguration. The compressed vCSI is then reported (842) to the gNB 820 and the location server.

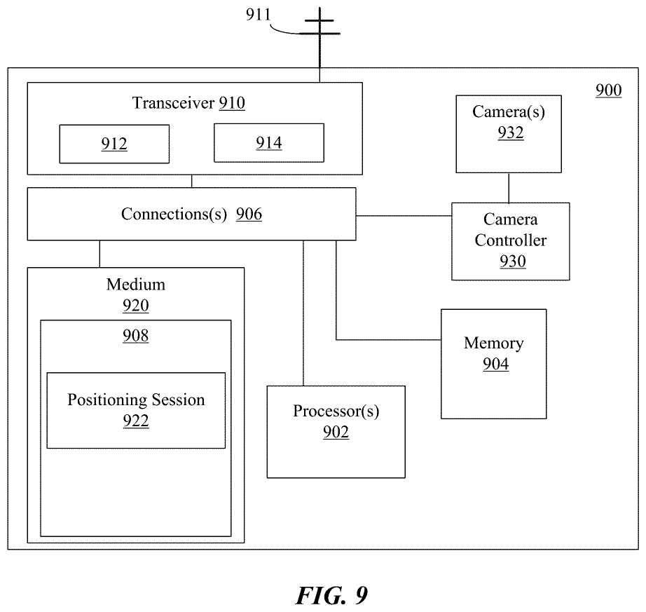

FIG. 9 shows a schematic block diagram illustrating certain exemplary features of a UE 900, e.g., which may be UE 104 shown in FIG. 1, enabled to support positioning of the UE using radio based CSI and vCSI, as described herein. The UE 900 may perform the process flow shown in FIG. 12. UE 900 may, for example, include one or more processors 902, memory 904, an external interface such as a transceiver 910 (e.g., wireless network interface), which may be operatively coupled with one or more connections 906 (e.g., buses, lines, fibers, links, etc.) to non-transitory computer readable medium 920 and memory 904. The UE 900 may further include additional items, which are not shown, such as a user interface that may include e.g., a display, a keypad or other input device, such as virtual keypad on the display, through which a user may interface with the UE 900, or a satellite positioning system receiver. In certain example implementations, all or part of UE 900 may take the form of a chipset, and/or the like. Transceiver 910 may, for example, include a transmitter 912 enabled to transmit one or more signals over one or more types of wireless communication networks and a receiver 914 to receive one or more signals transmitted over the one or more types of wireless communication networks. For example, as discussed above, the transceiver 910 and transmitter 912 may be capable of transmitting and receiving signals in accordance with any suitable wireless communication protocols, such as 4G and 5G cellular networks, WiFi, Bluetooth, UWB, and so on.

While not shown for simplicity, the UE 900 may also include one or more receivers capable of receiving satellite positioning signals. For example, the UE 900 may include a SPS/GNSS receiver which may be connected to one or more antennas, respectively, and may provide means for receiving and/or measuring satellite positioning signals. The satellite positioning signals may be GPS signals, global navigation satellite system (GLONASS) signals, Galileo signals, Beidou signals, Indian Regional Navigation Satellite System (NAVIC), Quasi-Zenith Satellite System (QZSS), and so on.

Further, while not shown for simplicity, the UE 900 may include or be coupled to one or more sensors configured for sensing or detecting information associated with movement of the UE 900, orientation of the UE 900, acceleration of the UE 900, and so on. For example, these sensors may be coupled to the one or more processors to provide means for sensing or detecting movement and/or orientation information that is independent of motion data derived from signals received by the antennas 911 or the transceiver 910. By way of example, the sensor(s) may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) may include a plurality of different types of devices and combine their outputs in order to provide motion and/or orientation information. For example, the sensor(s) may use a combination of a multi-axis accelerometer and orientation sensors to provide the ability to compute positions in two-dimensional (2D) and/or three-dimensional (3D) coordinate systems.

In some embodiments, the UE 900 may include one or more cameras 932. The cameras 932 may include one or more cameras capable of capturing still images (such as individual captured image frames) and/or capturing video (such as a succession of captured image frames). The cameras 932 may each include a single image sensor module or any other suitable module with one or more image sensors, such as one or more CMOS image sensors. Further, the cameras 932 may be capable of capturing images or video frames in a variety of manners. For example, one or more of the cameras 932 may be capable of movement, in order to direct the camera in a desired direction, such as a desired angle in two-dimensional or three-dimensional space. Further, one or more of the cameras 932 may be capable of various levels of optical and/or digital zoom. Additionally, one or more of the cameras 932 may be capable of focusing captured images at a specified distance or within a range of specified distances. Such focusing may be achieved using any suitable techniques, such as various autofocus techniques, phase detection, face detection, and so on. Note that while the cameras 932 are shown as located within the UE 900, in some other aspects one or more of the cameras 932 may be external to the UE 900 but coupled to the UE 900 using one or more wired or wireless connections.

In some aspects, the cameras 932 may be controlled using a camera controller 930, which may control the cameras 932, for example configuring the cameras 932 to capture images and/or video at various angles, focus such images at suitable distances, control which cameras of the cameras 932 are used to capture the images or video, and so on.

In some embodiments, UE 900 may include antenna 911, which may be internal or external. UE antenna 911 may be used to transmit and/or receive signals processed by transceiver 910. In some embodiments, UE antenna 911 may be coupled to transceiver 910. In some embodiments, measurements of signals received (transmitted) by UE 900 may be performed at the point of connection of the UE antenna 911 and transceiver 910. For example, the measurement point of reference for received (transmitted) RF signal measurements may be an input (output) terminal of the receiver 914 (transmitter 912) and an output (input) terminal of the UE antenna 911. In a UE 900 with multiple UE antennas 911 or antenna arrays, the antenna connector may be viewed as a virtual point representing the aggregate output (input) of multiple UE antennas. In some embodiments, UE 900 may determine positioning information based on exchanged radio signals and may determine vCSI based on one or more images captured by the camera(s) 932 based on the processing of received signals by the one or more processors 902 and may transmit the positioning information and vCSI using the output terminal of the transmitter 912.

The one or more processors 902 may be implemented using a combination of hardware, firmware, and software. For example, the one or more processors 902 may be configured to perform the functions discussed herein by implementing one or more instructions or program code 908 on a non-transitory computer readable medium, such as medium 920 and/or memory 904. In some embodiments, the one or more processors 902 may represent one or more circuits configurable to perform at least a portion of a data signal computing procedure or process related to the operation of UE 900.

The medium 920 and/or memory 904 may store instructions or program code 908 that contain executable code or software instructions that when executed by the one or more processors 902 cause the one or more processors 902 to operate as a special purpose computer programmed to perform the techniques disclosed herein. As illustrated in UE 900, the medium 920 and/or memory 904 may include one or more components or modules that may be implemented by the one or more processors 902 to perform the methodologies described herein. While the components or modules are illustrated as software in medium 920 that is executable by the one or more processors 902, it should be understood that the components or modules may be stored in memory 904 or may be dedicated hardware either in the one or more processors 902 or off the processors. A number of software modules and data tables may reside in the medium 920 and/or memory 904 and be utilized by the one or more processors 902 in order to manage both communications and the functionality described herein. It should be appreciated that the organization of the contents of the medium 920 and/or memory 904 as shown in UE 900 is merely exemplary, and as such the functionality of the modules and/or data structures may be combined, separated, and/or be structured in different ways depending upon the implementation of the UE 900.

The medium 920 and/or memory 904 may include a positioning session module 922 that when implemented by the one or more processors 902 configures the one or more processors 902 to engage in a positioning session for the UE. For example, the one or more processors 902 may be configured to engage in a positioning session by providing positioning capabilities to a location server, via the transceiver 910. The one or more processors 902 may be configured to receive positioning assistance data from a location server and/or serving base station, via the transceiver 910. The one or more processors 902 may be configured to perform positioning measurements, e.g., determining location information or related channel state information, using the transceiver 910 and the cameras 932. The one or more processors 902 may further be configured to provide location information reports, including radio-based location information and vCSI based location information, via the transceiver 910, to a network node, such as location server, serving base station or a sidelink UE.

The methodologies described herein may be implemented by various means depending upon the application. For example, these methodologies may be implemented in hardware, firmware, software, or any combination thereof. For a hardware implementation, the one or more processors 902 may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine readable medium tangibly embodying instructions may be used in implementing the methodologies described herein. For example, software codes may be stored in a non-transitory computer readable medium 920 or memory 904 that is connected to and executed by the one or more processors 902. Memory may be implemented within the one or more processors or external to the one or more processors. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or program code 908 on a non-transitory computer readable medium, such as medium 920 and/or memory 904. Examples include computer readable media encoded with a data structure and computer readable media encoded with a computer program 908. For example, the non-transitory computer readable medium including program code 908 stored thereon may include program code 908 to support positioning of the UE 900 based on exchanged radio signals and on vCSI generated from captured video signals in a manner consistent with disclosed embodiments. Non-transitory computer readable medium 920 includes physical computer storage media. A storage medium may be any available medium that can be accessed by a computer. By way of example, and not limitation, such non-transitory computer readable media can comprise RAM, ROM, EEPROM, CD-ROM or other optical disk storage, magnetic disk storage or other magnetic storage devices, or any other medium that can be used to store desired program code 908 in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer readable media.

In addition to storage on computer readable medium 920, instructions and/or data may be provided as signals on transmission media included in a communication apparatus. For example, a communication apparatus may include a transceiver 910 having signals indicative of instructions and data. The instructions and data are configured to cause one or more processors to implement the functions outlined in the claims. That is, the communication apparatus includes transmission media with signals indicative of information to perform disclosed functions.

Memory 904 may represent any data storage mechanism. Memory 604 may include, for example, a primary memory and/or a secondary memory. Primary memory may include, for example, a random access memory, read only memory, etc. While illustrated in this example as being separate from one or more processors 902, it should be understood that all or part of a primary memory may be provided within or otherwise co-located/coupled with the one or more processors 902. Secondary memory may include, for example, the same or similar type of memory as primary memory and/or one or more data storage devices or systems, such as, for example, a disk drive, an optical disc drive, a tape drive, a solid state memory drive, etc.

In certain implementations, secondary memory may be operatively receptive of, or otherwise configurable to couple to a non-transitory computer readable medium 920. As such, in certain example implementations, the methods and/or apparatuses presented herein may take the form in whole or part of a computer readable medium 920 that may include computer implementable code 908 stored thereon, which if executed by one or more processors 902 may be operatively enabled to perform all or portions of the example operations as described herein. Computer readable medium 920 may be a part of memory 904.

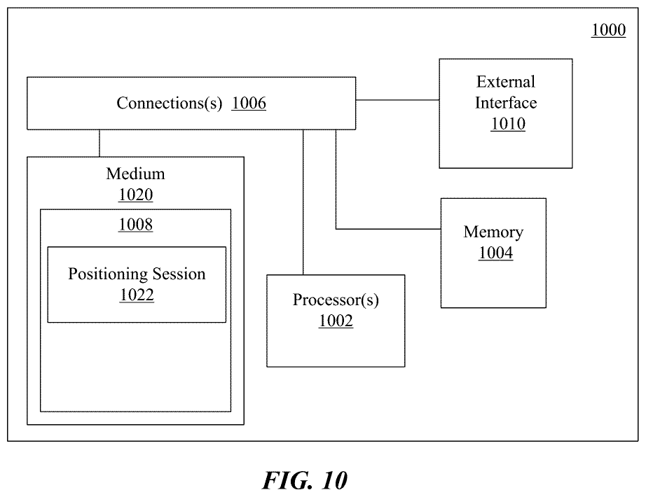

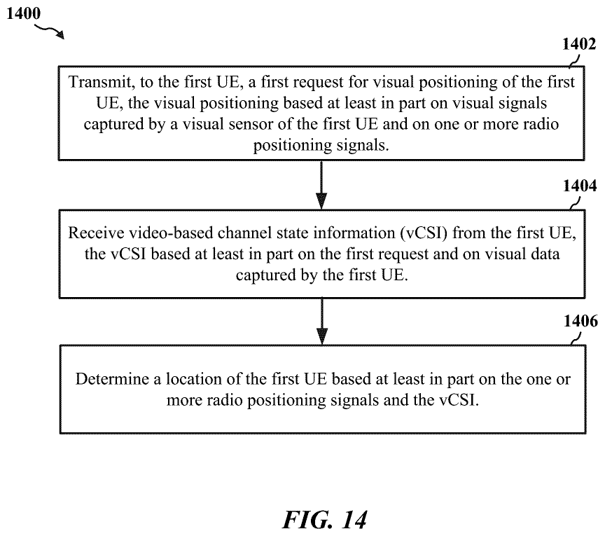

FIG. 10 shows a schematic block diagram illustrating certain exemplary features of a location server 1000, e.g., location server 172, enabled to support positioning of the UE using relative location information messages, as described herein. The location server 1000 may be, e.g., an E-SMLC or LMF. The location server 1000 may perform the process flow shown in FIG. 14. Location server 1000 may, for example, include one or more processors 1002, memory 1004, and an external interface 1010 (e.g., wireline or wireless network interface to other network entities, such as core network entities and base stations), which may be operatively coupled with one or more connections 1006 (e.g., buses, lines, fibers, links, etc.) to non-transitory computer readable medium 1020 and memory 1004. The location server 1000 may further include additional items, which are not shown, such as a user interface that may include e.g., a display, a keypad or other input device, such as virtual keypad on the display, through which a user may interface with the location server. In certain example implementations, all or part of location server 1000 may take the form of a chipset, and/or the like. The external interface 1010 may be a wired or wireless interface capable of connecting to base stations in the RAN or network entities, such as an AMF or MME.

The one or more processors 1002 may be implemented using a combination of hardware, firmware, and software. For example, the one or more processors 1002 may be configured to perform the functions discussed herein by implementing one or more instructions or program code 1008 on a non-transitory computer readable medium, such as medium 1020 and/or memory 1004. In some embodiments, the one or more processors 1002 may represent one or more circuits configurable to perform at least a portion of a data signal computing procedure or process related to the operation of location server 1000.

The medium 1020 and/or memory 1004 may store instructions or program code 1008 that contain executable code or software instructions that when executed by the one or more processors 1002 cause the one or more processors 1002 to operate as a special purpose computer programmed to perform the techniques disclosed herein. As illustrated in location server 1000, the medium 1020 and/or memory 1004 may include one or more components or modules that may be implemented by the one or more processors 1002 to perform the methodologies described herein. While the components or modules are illustrated as software in medium 1020 that is executable by the one or more processors 1002, it should be understood that the components or modules may be stored in memory 1004 or may be dedicated hardware either in the one or more processors 1002 or off the processors. A number of software modules and data tables may reside in the medium 1020 and/or memory 1004 and be utilized by the one or more processors 1002 in order to manage both communications and the functionality described herein. It should be appreciated that the organization of the contents of the medium 1020 and/or memory 1004 as shown in location server 1000 is merely exemplary, and as such the functionality of the modules and/or data structures may be combined, separated, and/or be structured in different ways depending upon the implementation of the location server 1000.

The medium 1020 and/or memory 1004 may include a positioning session module 1022 that when implemented by the one or more processors 1002 configures the one or more processors 1002 to engage in a positioning session for the UE. For example, the one or more processors 1002 may be configured to engage in a positioning session by requesting and receive positioning capabilities from a UE, via the external interface 1010. The one or more processors 1002 may be configured to generate and send positioning assistance data to the UE and/or serving base station, via the external interface 1010. The one or more processors 1002 may further be configured to receive location information messages including location information relating to exchanged radio signals and relating to vCSI, via the external interface 1010, from the UE. The one or more processors 1002 may further be configured to determine a position location for the UE based on the received radio-based location information and vCSI based location information included in the location information messages.

The methodologies described herein may be implemented by various means depending upon the application. For example, these methodologies may be implemented in hardware, firmware, software, or any combination thereof. For a hardware implementation, the one or more processors 1002 may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine readable medium tangibly embodying instructions may be used in implementing the methodologies described herein. For example, software codes may be stored in a non-transitory computer readable medium 1020 or memory 1004 that is connected to and executed by the one or more processors 1002. Memory may be implemented within the one or more processors or external to the one or more processors. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or program code 1008 on a non-transitory computer readable medium, such as medium 1020 and/or memory 1004. Examples include computer readable media encoded with a data structure and computer readable media encoded with a computer program 1008. For example, the non-transitory computer readable medium including program code 1008 stored thereon may include program code 708 to support positioning of the UE using reference and relative location information in a manner consistent with disclosed embodiments. Non-transitory computer readable medium 1020 includes physical computer storage media. A storage medium may be any available medium that can be accessed by a computer. By way of example, and not limitation, such non-transitory computer readable media can comprise RAM, ROM, EEPROM, CD-ROM or other optical disk storage, magnetic disk storage or other magnetic storage devices, or any other medium that can be used to store desired program code 1008 in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer readable media.

In addition to storage on computer readable medium 1020, instructions and/or data may be provided as signals on transmission media included in a communication apparatus. For example, a communication apparatus may include an external interface 1010 having signals indicative of instructions and data. The instructions and data are configured to cause one or more processors to implement the functions outlined in the claims. That is, the communication apparatus includes transmission media with signals indicative of information to perform disclosed functions.

Memory 1004 may represent any data storage mechanism. Memory 1004 may include, for example, a primary memory and/or a secondary memory. Primary memory may include, for example, a random access memory, read only memory, etc. While illustrated in this example as being separate from one or more processors 1002, it should be understood that all or part of a primary memory may be provided within or otherwise co-located/coupled with the one or more processors 1002. Secondary memory may include, for example, the same or similar type of memory as primary memory and/or one or more data storage devices or systems, such as, for example, a disk drive, an optical disc drive, a tape drive, a solid state memory drive, etc.

In certain implementations, secondary memory may be operatively receptive of, or otherwise configurable to couple to a non-transitory computer readable medium 1020. As such, in certain example implementations, the methods and/or apparatuses presented herein may take the form in whole or part of a computer readable medium 1020 that may include computer implementable code 1008 stored thereon, which if executed by one or more processors 1002 may be operatively enabled to perform all or portions of the example operations as described herein. Computer readable medium 1020 may be a part of memory 1004.

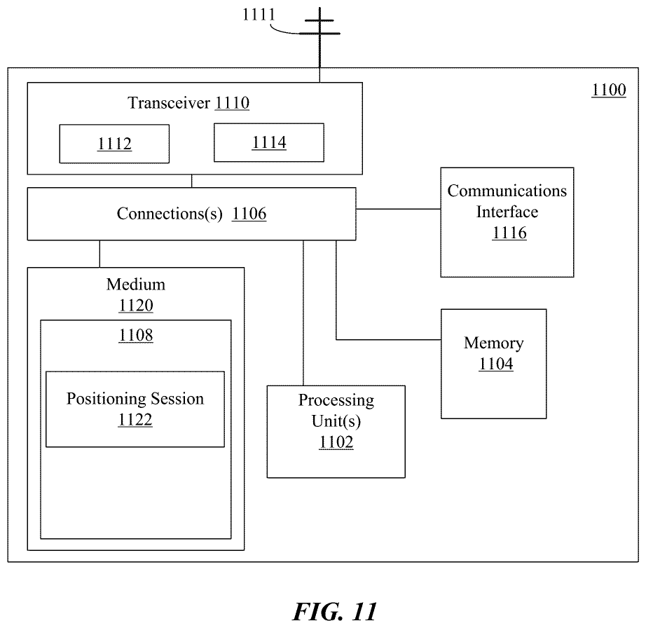

FIG. 11 shows a schematic block diagram illustrating certain exemplary features of a base station 1100, e.g., base station 102 in FIG. 1, enabled to support positioning of the UE using relative location information messages, as described herein. The base station 1100 may be an eNB or gNB. The base station 1100 may perform the process flow shown in FIG. 14. Base station 1100 may, for example, include one or more processors 1102, memory 1104, an external interface, which may include a transceiver 1110 (e.g., wireless network interface) and a communications interface 1116 (e.g., wireline or wireless network interface to other base stations and/or entities in the core network such as a location server), which may be operatively coupled with one or more connections 1106 (e.g., buses, lines, fibers, links, etc.) to non-transitory computer readable medium 1120 and memory 1104. The base station 1100 may further include additional items, which are not shown, such as a user interface that may include e.g., a display, a keypad or other input device, such as virtual keypad on the display, through which a user may interface with the base station. In certain example implementations, all or part of base station 1100 may take the form of a chipset, and/or the like. Transceiver 1110 may, for example, include a transmitter 1112 enabled to transmit one or more signals over one or more types of wireless communication networks and a receiver 1114 to receive one or more signals transmitted over the one or more types of wireless communication networks. The communications interface 1116 may be a wired or wireless interface capable of connecting to other base stations in the RAN or network entities, such as a location server 172 shown in FIG. 1.

In some embodiments, base station 1100 may include antenna 1111, which may be internal or external. Antenna 1111 may be used to transmit and/or receive signals processed by transceiver 1110. In some embodiments, antenna 1111 may be coupled to transceiver 1110. In some embodiments, measurements of signals received (transmitted) by base station 1100 may be performed at the point of connection of the antenna 1111 and transceiver 1110. For example, the measurement point of reference for received (transmitted) RF signal measurements may be an input (output) terminal of the receiver 1114 (transmitter 1112) and an output (input) terminal of the antenna 1111. In a base station 1100 with multiple antennas 1111 or antenna arrays, the antenna connector may be viewed as a virtual point representing the aggregate output (input) of multiple antennas. In some embodiments, base station 1100 may receive location information messages associated with radio- and vCSI-based positioning of a UE using the input terminal of the receiver 1114 and determine locations of the UE based on processing of the received location information messages by the one or more processors 1102.

The one or more processors 1102 may be implemented using a combination of hardware, firmware, and software. For example, the one or more processors 1102 may be configured to perform the functions discussed herein by implementing one or more instructions or program code 1108 on a non-transitory computer readable medium, such as medium 1120 and/or memory 1104. In some embodiments, the one or more processors 1102 may represent one or more circuits configurable to perform at least a portion of a data signal computing procedure or process related to the operation of base station 1100.

The medium 1120 and/or memory 1104 may store instructions or program code 1108 that contain executable code or software instructions that when executed by the one or more processors 1102 cause the one or more processors 1102 to operate as a special purpose computer programmed to perform the techniques disclosed herein. As illustrated in base station 1100, the medium 1120 and/or memory 1104 may include one or more components or modules that may be implemented by the one or more processors 1102 to perform the methodologies described herein. While the components or modules are illustrated as software in medium 1120 that is executable by the one or more processors 1102, it should be understood that the components or modules may be stored in memory 1104 or may be dedicated hardware either in the one or more processors 1102 or off the processors. A number of software modules and data tables may reside in the medium 1120 and/or memory 1104 and be utilized by the one or more processors 1102 in order to manage both communications and the functionality described herein. It should be appreciated that the organization of the contents of the medium 1120 and/or memory 1104 as shown in base station 1100 is merely exemplary, and as such the functionality of the modules and/or data structures may be combined, separated, and/or be structured in different ways depending upon the implementation of the base station 1100.

The medium 1120 and/or memory 1104 may include a positioning session module 1122 that when implemented by the one or more processors 1102 configures the one or more processors 1102 to engage in a positioning session for the UE. For example, the one or more processors 1102 may be configured transmit and receive messages for the UE 104 and location server 172 to engage in a positioning session. The one or more processors 1102 may be configured to receive, e.g., via the transceiver 1110, location information messages, and to determine positions of the UE based on the radio-based location information and vCSI based location information in the received location information messages.

The methodologies described herein may be implemented by various means depending upon the application. For example, these methodologies may be implemented in hardware, firmware, software, or any combination thereof. For a hardware implementation, the one or more processors 1102 may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine readable medium tangibly embodying instructions may be used in implementing the methodologies described herein. For example, software codes may be stored in a non-transitory computer readable medium 1120 or memory 1104 that is connected to and executed by the one or more processors 1102. Memory may be implemented within the one or more processors or external to the one or more processors. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or program code 1108 on a non-transitory computer readable medium, such as medium 1120 and/or memory 1104. Examples include computer readable media encoded with a data structure and computer readable media encoded with a computer program 1108. For example, the non-transitory computer readable medium including program code 1108 stored thereon may include program code 808 to support positioning of the UE using radio- and vCSI-based location information in a manner consistent with disclosed embodiments. Non-transitory computer readable medium 1120 includes physical computer storage media. A storage medium may be any available medium that can be accessed by a computer. By way of example, and not limitation, such non-transitory computer readable media can comprise RAM, ROM, EEPROM, CD-ROM or other optical disk storage, magnetic disk storage or other magnetic storage devices, or any other medium that can be used to store desired program code 1108 in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer readable media.

In addition to storage on computer readable medium 1120, instructions and/or data may be provided as signals on transmission media included in a communication apparatus. For example, a communication apparatus may include a transceiver 1110 having signals indicative of instructions and data. The instructions and data are configured to cause one or more processors to implement the functions outlined in the claims. That is, the communication apparatus includes transmission media with signals indicative of information to perform disclosed functions.

Memory 1104 may represent any data storage mechanism. Memory 1104 may include, for example, a primary memory and/or a secondary memory. Primary memory may include, for example, a random access memory, read only memory, etc. While illustrated in this example as being separate from one or more processors 1102, it should be understood that all or part of a primary memory may be provided within or otherwise co-located/coupled with the one or more processors 1102. Secondary memory may include, for example, the same or similar type of memory as primary memory and/or one or more data storage devices or systems, such as, for example, a disk drive, an optical disc drive, a tape drive, a solid state memory drive, etc.

In certain implementations, secondary memory may be operatively receptive of, or otherwise configurable to couple to a non-transitory computer readable medium 1120. As such, in certain example implementations, the methods and/or apparatuses presented herein may take the form in whole or part of a computer readable medium 1120 that may include computer implementable code 1108 stored thereon, which if executed by one or more processors 1102 may be operatively enabled to perform all or portions of the example operations as described herein. Computer readable medium 1120 may be a part of memory 1104.

FIG. 12 shows a flowchart for an exemplary method 1200 for supporting positioning of a first user equipment (UE) in a wireless network performed by the first UE, such as UE 104, in a manner consistent with disclosed implementation.

At block 1202, the first UE receives a first request for visual positioning of the first UE, the visual positioning based at least in part on visual signals captured by a visual sensor of the first UE and on one or more radio positioning signals. For example, the first request may include a relative direction for pointing the visual sensor of the first UE. The first request may further indicate a distance associated with one of the one or more wireless devices. In some aspects, the relative direction indicates at least a threshold distance. In some aspects, the first request further indicates a category of object of interest. A means for receiving the first request may include, with respect to FIG. 9, the positioning session 922 stored on medium 920 or within program code 908 executed by the one or more processors 902 and may be received by antenna 911 or the receiver 914.

At block 1204, the first UE may capture visual data based on the first request. For example, the first UE may capture visual data associated with one or more wireless devices within visual range of the first UE. In some aspects, the one or more radio positioning signals are received from one of the one or more wireless devices within visual range of the first UE. A means for capturing the visual data may include, with respect to FIG. 9, the cameras 932 controlled by the camera controller 930, and the positioning session 922 stored on medium 920 or within program code 908 executed by the one or more processors 902.

At block 1206, the first UE may determine video-based channel state information (vCSI) based on the captured visual data. For example, the vCSI may be associated with a presence of at least one of the one or more wireless devices within visible range of the first UE, and the method 1200 may further include receiving a request, based at least in part on the vCSI, from a network entity such as a base station or a location server associated with the first UE requesting radio positioning of one of the one or more wireless devices, receiving the one or more radio positioning signals from the at least one of the one or more wireless devices, and transmitting a response to the network entity based at least in part on the one or more radio positioning signals. In some aspects, the relative direction in the first request indicates at least a threshold distance, wherein the vCSI is only determined for objects within the threshold distance of the first UE. In some aspects, the vCSI is determined based on the captured visual data based at least in part on a trained machine learning model. In some aspects the vCSI is based at least in part on one or more tags indicating one or more zone properties associated with the visual data. In some aspects, the one or more zone properties include one or more of an indoor zone category, an outdoor zone category, a sky zone category, a ground zone category, a reflection zone category, a blockage zone category, a room size zone category. In some aspects, the vCSI is determined based at least in part on a category of object of interest indicated in the first request. A means for determining the vCSI may include, with respect to FIG. 9, the cameras 932 controlled by the camera controller 930, and the positioning session 922 stored on medium 920 or within program code 908 executed by the one or more processors 902.

At block 1208, the first UE may transmit the vCSI to a network entity associated with the first UE. A means for transmitting the vCSI may include, with respect to FIG. 9, the positioning session 922 stored on medium 920 or within program code 908 executed by the one or more processors 902 and may be received by antenna 911 or the receiver 914.

In some implementations, the method 1200 may further include receiving, prior to receiving the first request, a sidelink positioning request requesting the first UE to determine positioning information associated with the relative direction, receiving the one or more positioning signals from one of one or more wireless devices within visual range of the first UE, and transmitting a response to the sidelink positioning request associated with the relative direction based at least in part on the one or more radio positioning signals.

In some aspects, the method 1200 may further include, prior to receiving the first request, receiving a request for radio-based positioning of the first UE, receiving the one or more radio positioning signals based on the request for radio-based positioning, determining one or more radio positioning measurements based on the one or more radio positioning signals, and transmitting one or more signals to the base station based on the one or more radio positioning measurements, wherein the first request is based at least in part on the one or more radio positioning measurements. In some aspects, the method 1200 may further include receiving one or more signals from the network entity indicating one or more points of interest determined to be proximate to the first UE based on the one or more positioning measurements, wherein the visual data is based at least in part on the one or more points of interest.

In some aspects, the method 1200 may further include, prior to receiving the first request, reporting one or more capabilities to the network entity associated with determining the vCSI, the one or more capabilities comprising one or more of a number of cameras coupled to the first UE, one or more visual zoom capabilities associated with the first UE, one or more ranges of motion associated with capturing the visual data, and one or more visual resolutions associated with capturing the visual data.

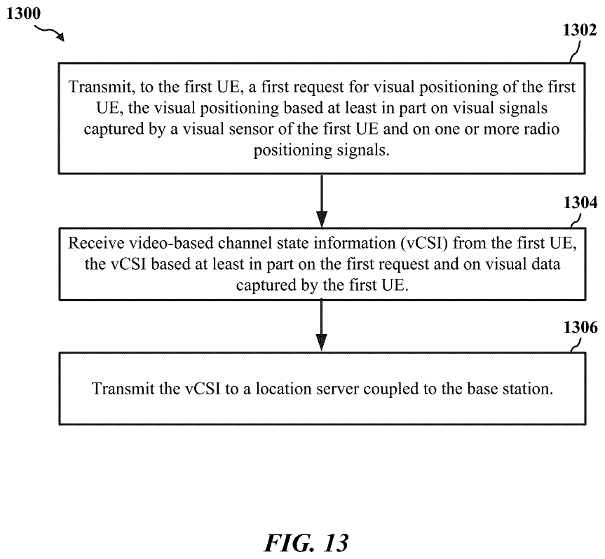

FIG. 13 shows a flowchart for an exemplary method 1300 for supporting positioning of a first user equipment (UE) in a wireless network performed by a serving base station in the wireless network, such as base station 102 shown in FIG. 1, in a manner consistent with disclosed implementation.

At block 1302, the location server may transmit, to the first UE, a first request for visual positioning of the first UE, the visual positioning based at least in part on visual signals captured by a visual sensor of the first UE and on one or more radio positioning signals. For example, the first request may indicate a relative direction for pointing the visual sensor of the first UE. The first request may further include a distance associated with one of the one or more wireless devices. In some aspects, the relative direction indicates at least a threshold distance. In some aspects, the first request further indicates a category of object of interest. In some aspects, a means for receiving the reference location information message may include, with respect to FIG. 11, positioning session 1122 stored on medium 1120 or within program code 1108 executed by the one or more processors 1102, which may transmit the first request via transceiver 1110 using the antennas 1111.

At block 1304, the base station may receive video-based channel state information (vCSI) from the first UE, where the vCSI is based at least in part on the first request and on visual data captured by the first UE. In some aspects, the visual data is associated with one or more wireless devices within visual range of the first UE. In some aspects, the vCSI is determined based on the captured visual data based at least in part on a trained machine learning model. In some aspects, the vCSI is based at least in part on one or more tags indicating one or more zone properties associated with the visual data. In some aspects, the one or more zone properties include one or more of an indoor zone category, an outdoor zone category, a sky zone category, a ground zone category, a reflection zone category, a blockage zone category, a room size zone category. In some aspects, the vCSI is determined based at least in part on a category of object of interest indicated in the first request. A means for receiving the vCSI may include, with respect to FIG. 11, positioning session 1122 stored on medium 1120 or within program code 1108 executed by the one or more processors 1102, which may receive the vCSI via transceiver 1110 using the antennas 1111.

At block 1306, the base station may transmit the vCSI to a location server coupled to the base station. A means for transmitting the vCSI to the location server may include, with respect to FIG. 11, positioning session 1122 stored on medium 1120 or within program code 1108 executed by the one or more processors 1102, which may receive the vCSI via transceiver 1110 using the antennas 1111.

In some aspects, the method 1300 further includes, prior to transmitting the first request, transmitting a request for radio-based positioning of the first UE, and receiving one or more signals from the first UE based on the one or more radio positioning signals, the one or more radio positioning signals indicating one or more positioning measurements performed by the first UE, wherein the first request is based at least in part on the one or more positioning measurements. In some aspects, the method 1300 further includes transmitting one or more signals to the first UE indicating one or more points of interest determined to be proximate to the first UE based on the one or more positioning measurements, wherein the visual data is based at least in part on the one or more points of interest.

In some aspects, the method 1300 further includes prior to transmitting the first request, receiving one or more messages from the first UE indicating one or more capabilities of the first UE associated with determining the vCSI, the one or more capabilities comprising one or more of a number of cameras coupled to the first UE, one or more visual zoom capabilities associated with the first UE, one or more ranges of motion associated with capturing the visual data, and one or more visual resolutions associated with capturing the visual data.

FIG. 14 shows a flowchart for an exemplary method 1400 for supporting positioning of a first user equipment (UE) in a wireless network performed by a location server associated with the UE in the wireless network, such as location server 172, in a manner consistent with disclosed implementation.

At block 1402, the location server transmits, to the first UE, a first request for visual positioning of the first UE, the visual positioning based at least in part on visual signals captured by a visual sensor of the first UE and on one or more radio positioning signals. For example, the first request may indicate a relative direction for pointing the visual sensor of the first UE. The first request may further include a distance associated with one of the one or more wireless devices. In some aspects, the relative direction indicates at least a threshold distance. In some aspects, the first request further indicates a category of object of interest. A means for transmitting the first request may include, with respect to FIG. 10, the positioning session 1022 stored in the medium 1020 or in the program code 1008 executed by the one or more processors 1002, which may transmit the first request via the antenna external interface 1010 or the connections 1006.

At block 1404, the location server receives video-based channel state information (vCSI) from the first UE, where the vCSI is based at least in part on the first request and on visual data captured by the first UE. In some aspects, the visual data is associated with one or more wireless devices within visual range of the first UE. In some aspects, the vCSI is determined based on the captured visual data based at least in part on a trained machine learning model. In some aspects, the vCSI is based at least in part on one or more tags indicating one or more zone properties associated with the visual data. In some aspects, the one or more zone properties include one or more of an indoor zone category, an outdoor zone category, a sky zone category, a ground zone category, a reflection zone category, a blockage zone category, a room size zone category. In some aspects, the vCSI is determined based at least in part on a category of object of interest indicated in the first request. A means for receiving the vCSI may include, with respect to FIG. 10, the positioning session 1022 stored in the medium 1020 or in the program code 1008 executed by the one or more processors 1002, which may receive the vCSI via the antenna external interface 1010 or the connections 1006.

At block 1406, location server may determine a location of the first UE based at least in part on the one or more radio positioning signals and the vCSI. A means for determining the location of the first UE may include, with respect to FIG. 10, the positioning session 1022 stored in the medium 1020 or in the program code 1008 executed by the one or more processors 1002.

In some aspects, the method 1400 further includes, prior to transmitting the first request, transmitting a request for radio-based positioning of the first UE, and receiving one or more signals from the first UE based on the one or more radio positioning signals, the one or more radio positioning signals indicating one or more positioning measurements performed by the first UE, wherein the first request is based at least in part on the one or more positioning measurements. In some aspects, the method 1400 further includes transmitting one or more signals to the first UE indicating one or more points of interest determined to be proximate to the first UE based on the one or more positioning measurements, wherein the visual data is based at least in part on the one or more points of interest.

In some aspects, the method 1400 further includes prior to transmitting the first request, receiving one or more messages from the first UE indicating one or more capabilities of the first UE associated with determining the vCSI, the one or more capabilities comprising one or more of a number of cameras coupled to the first UE, one or more visual zoom capabilities associated with the first UE, one or more ranges of motion associated with capturing the visual data, and one or more visual resolutions associated with capturing the visual data.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in certain implementations” or other like phrases in various places throughout this specification are not necessarily all referring to the same feature, example, and/or limitation. Furthermore, the particular features, structures, or characteristics may be combined in one or more examples and/or features.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe a plurality or some other combination of features, structures, or characteristics. Though, it should be noted that this is merely an illustrative example and claimed subject matter is not limited to this example.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein.

Implementation examples are described in the following numbered clauses:
Clause 1. A method performed by a first user equipment (UE) for supporting positioning of the UE in a wireless network, including:
receiving a first request for visual positioning of the first UE, the visual positioning based at least in part on visual signals captured by a visual sensor of the first UE and on one or more radio positioning signals;
capturing visual data based on the first request;
determining video-based channel state information (vCSI) based on the captured visual data; and transmitting the vCSI to a network entity associated with the first UE.
Clause 2. The method of clause 1, wherein the visual data is associated with one or more wireless devices within visual range of the first UE.
Clause 3. The method of clause 2, wherein the one or more radio positioning signals are received by the first UE from one of the one or more wireless devices within visual range of the first UE.
Clause 4. The method of clause 2, wherein the first request includes a distance associated with at least one of the one or more wireless devices.
Clause 5. The method of clause 2, wherein the first request further indicates a relative direction for pointing the visual sensor of the first UE, and wherein the method further including:
receiving, prior to receiving the first request a sidelink (SL) positioning request requesting the first UE to determine positioning information associated with the relative direction;
receiving the one or more positioning signals from one of the one or more wireless devices; and
transmitting a response to the SL positioning request associated with the relative direction based at least in part on the one or more radio positioning signals.
Clause 6. The method of clause 5, wherein the relative direction indicates at least a threshold distance, wherein the vCSI is only determined for objects within the threshold distance of the first UE.
Clause 7. The method of clause 2, wherein the vCSI is associated with a presence of at least one of the one or more wireless devices, wherein the method further includes:
receiving a request from the network entity requesting radio positioning of one of the one or more wireless devices, the request for radio positioning based at least in part on the vCSI;
receiving the one or more radio positioning signals from the at least one of the one or more wireless devices; and
transmitting a response to the network entity based at least in part on the one or more radio positioning signals.
Clause 8. The method of clause 1, wherein the vCSI is determined based on the captured visual data using a trained machine learning model.
Clause 9. The method of clause 1, wherein the vCSI is based at least in part on one or more tags, the one or more tags indicating one or more zone properties associated with the visual data.
Clause 10. The method of clause 9, wherein the one or more zone properties include one or more of an indoor zone category, an outdoor zone category, a sky zone category, a ground zone category, a reflection zone category, a blockage zone category, a room size zone category.
Clause 11. The method of clause 1, wherein the first request further indicates a category of object of interest, wherein the vCSI is determined based at least in part on the category of object of interest.
Clause 12. The method of clause 1, further including, prior to receiving the first request:
receiving a request for radio-based positioning of the first UE;
receiving the one or more radio positioning signals based on the request for radio-based positioning;
determining one or more radio positioning measurements based on the one or more radio positioning signals; and
transmitting one or more signals to the base station indicating the one or more radio positioning measurements
wherein the first request is based at least in part on the one or more radio positioning measurements.
Clause 13. The method of clause 12, further including receiving one or more signals from the base station indicating one or more points of interest determined to be proximate to the first UE based on the one or more radio positioning measurements, wherein the visual data is based at least in part on the one or more points of interest.
Clause 14. The method of clause 1, further including, prior to receiving the first request, reporting one or more capabilities to the network entity associated with determining the vCSI, the one or more capabilities comprising one or more of a number of cameras coupled to the first UE, one or more visual zoom capabilities associated with the first UE, one or more ranges of motion associated with capturing the visual data, and one or more visual resolutions associated with capturing the visual data.
Clause 15. A first user equipment (UE) configured to transmit location information messages in a wireless network, including:
a wireless transceiver configured to wirelessly communicate with entities in the wireless network;
at least one memory;
at least one processor coupled to the wireless transceiver and the at least one memory, wherein the at least one processor is configured to:
   receive a first request for visual positioning of the first UE, the visual positioning based at least in part on visual signals captured by a visual sensor of the first UE and on one or more radio positioning signals;
   capture visual data based on the first request;
   determine video-based channel state information (vCSI) based on the captured visual data; and
   transmit the vCSI to a network entity associated with the first UE.
Clause 16. The first UE of clause 15, wherein the visual data is associated with one or more wireless devices within visual range of the first UE.
Clause 17. The first UE of clause 16, wherein the one or more radio positioning signals are received by the first UE from one of the one or more wireless devices within visual range of the first UE.
Clause 18. The first UE of clause 16, wherein the first request includes a distance associated with at least one of the one or more wireless devices.
Clause 19. The first UE of clause 16, wherein the first request further indicates a relative direction for pointing the visual sensor of the first UE, and wherein the at least one processor is further configured to:
   receive, prior to receiving the first request a sidelink (SL) positioning request requesting the first UE to determine positioning information associated with the relative direction;
   receive the one or more positioning signals from one of the one or more wireless devices; and
   transmit a response to the SL positioning request associated with the relative direction based at least in part on the one or more radio positioning signals.

Clause 20. The first UE of clause 16, wherein the vCSI is associated with a presence of at least one of the one or more wireless devices, wherein the at least one processor is further configured to:
receive a request from the network entity requesting radio positioning of one of the one or more wireless devices, the request for radio positioning based at least in part on the vCSI;
receive the one or more radio positioning signals from the at least one of the one or more wireless devices; and
transmit a response to the network entity based at least in part on the one or more radio positioning signals.
Clause 21. The first UE of clause 15, wherein the vCSI is determined based on the captured visual data using a trained machine learning model.
Clause 22. The first UE of clause 15, wherein the at least one processor is further configured to, prior to receiving the first request:
receive a request for radio-based positioning of the first UE;
receive the one or more radio positioning signals based on the request for radio-based positioning;
determine one or more radio positioning measurements based on the one or more radio positioning signals; and
transmit one or more signals to the base station indicating the one or more radio positioning measurements
wherein the first request is based at least in part on the one or more radio positioning measurements.
Clause 23. The first UE of clause 22, wherein the at least one processor is further configured to receive one or more signals from the base station indicating one or more points of interest determined to be proximate to the first UE based on the one or more radio positioning measurements, wherein the visual data is based at least in part on the one or more points of interest.
Clause 24. The first UE of clause 15, wherein the at least one processor is further configured to, prior to receiving the first request, report one or more capabilities to the base station associated with determining the vCSI, the one or more capabilities comprising one or more of a number of cameras coupled to the first UE, one or more visual zoom capabilities associated with the first UE, one or more ranges of motion associated with capturing the visual data, and one or more visual resolutions associated with capturing the visual data.
Clause 25. A method for supporting positioning of a first user equipment (UE) in a wireless network, performed by a location server in the wireless network and including:
transmitting, to the first UE, a first request for visual positioning of the first UE, the visual positioning based at least in part on visual signals captured by a visual sensor of the first UE and on one or more radio positioning signals;
receiving video-based channel state information (vCSI) from the first UE, the vCSI based at least in part on the first request and on visual data captured by the first UE; and
determining a location of the first UE based at least in part on the one or more radio positioning signals and the vCSI.
Clause 26. The method of clause 25, wherein the visual data is associated with one or more wireless devices within visual range of the first UE.
Clause 27. The method of clause 26, wherein the first request indicates a distance associated with at least one of the one or more wireless devices.
Clause 28. The method of clause 26, wherein the one or more radio positioning signals are received by the first UE from one of the one or more wireless devices within visual range of the first UE.
Clause 29. The method of clause 26, wherein the first request further indicates a relative direction for pointing the visual sensor of the first UE, and wherein the method further includes:
transmitting, prior to transmitting the first request, a sidelink (SL) positioning request to the first UE requesting the first UE to determine positioning information associated with the relative direction;
receiving, from the first UE, a response to the SL positioning request associated with the relative direction based at least in part on the one or more radio positioning signals, wherein the one or more radio positioning signals are exchanged between the first UE and one of the one or more wireless devices.
Clause 30. The method of clause 26, wherein the vCSI is associated with a presence of at least one of the one or more wireless devices, wherein the method further includes:
transmitting a request to the first UE requesting radio positioning of one of the one or more wireless devices, the request for radio positioning based at least in part on the vCSI; and
receiving a response from the first UE based at least in part on the one or more radio positioning signals, wherein the one or more radio positioning signals are exchanged between the first UE and the one of the one or more wireless devices.
Clause 31. The method of clause 25, wherein the vCSI is determined based on the captured visual data using a trained machine learning model.
Clause 32. The method of clause 25, further comprising, prior to transmitting the first request:
transmitting a request for radio-based positioning of the first UE;
receiving one or more signals from the first UE based on the one or more radio positioning signals, the one or more radio positioning signals indicating one or more radio positioning measurements performed by the first UE;
wherein the first request is based at least in part on the one or more radio positioning measurements.
Clause 33. The method of clause 32, further including transmitting one or more signals to the first UE indicating one or more points of interest determined to be proximate to the first UE based on the one or more radio positioning measurements, wherein the visual data is based at least in part on the one or more points of interest.
Clause 34. The method of clause 25, further including, prior to transmitting the first request, receiving one or more messages from the first UE indicating one or more capabilities of the first UE associated with determining the vCSI, the one or more capabilities comprising one or more of a number of cameras coupled to the first UE, one or more visual zoom capabilities associated with the first UE, one or more ranges of motion associated with capturing the visual data, and one or more visual resolutions associated with capturing the visual data.
Clause 35. A location server configured to support positioning of a user equipment (UE) in a wireless network, including:
an external interface configured to communicate with entities in the wireless network;
at least one memory;
at least one processor coupled to the external interface and the at least one memory, wherein the at least one processor is configured to:
   transmit, to the first UE, a first request for visual positioning of the first UE, the visual positioning based at least in part on visual signals captured by a visual sensor of the first UE and on one or more radio positioning signals;
   receive video-based channel state information (vCSI) from the first UE, the vCSI based at least in part on the first request and on visual data captured by the first UE; and
   determine a location of the first UE based at least in part on the one or more radio positioning signals and the vCSI.
Clause 36. The location server of clause 35, wherein the visual data is associated with one or more wireless devices within visual range of the first UE.
Clause 37. The location server of clause 36, wherein the first request indicates a distance associated with at least one of the one or more wireless devices.
Clause 38. The location server of clause 36, wherein the one or more radio positioning signals are received by the first UE from one of the one or more wireless devices within visual range of the first UE.
Clause 39. The location server of clause 36, wherein the first request further indicates a relative direction for pointing the visual sensor of the first UE, and wherein the at least one processor is further configured to:
transmit, prior to transmitting the first request, a sidelink (SL) positioning request to the first UE requesting the first UE to determine positioning information associated with the relative direction;
receive, from the first UE, a response to the SL positioning request associated with the relative direction based at least in part on the one or more radio positioning signals, wherein the one or more radio positioning signals are exchanged between the first UE and one of the one or more wireless devices.
Clause 40. The location server of clause 36, wherein the vCSI is associated with a presence of at least one of the one or more wireless devices, wherein the at least one processor is further configured to:
transmit a request to the first UE requesting radio positioning of one of the one or more wireless devices, the request for radio positioning based at least in part on the vCSI; and
receive a response from the first UE based at least in part on the one or more radio positioning signals, wherein the one or more radio positioning signals are exchanged between the first UE and the one of the one or more wireless devices.
Clause 41. The location server of clause 35, wherein the vCSI is determined based on the captured visual data using a trained machine learning model.
Clause 42. The location server of clause 35, wherein the at least one processor is further configured to, prior to transmitting the first request:
transmit a request for radio-based positioning of the first UE;
receive one or more signals from the first UE based on the one or more radio positioning signals, the one or more radio positioning signals indicating one or more radio positioning measurements performed by the first UE;
wherein the first request is based at least in part on the one or more radio positioning measurements.
Clause 43. The location server of clause 42, wherein the at least one processor is further configured to transmit one or more signals to the first UE indicating one or more points of interest determined to be proximate to the first UE based on the one or more radio positioning measurements, wherein the visual data is based at least in part on the one or more points of interest.
Clause 44. A method for supporting positioning of a user equipment (UE) in a wireless network by a serving base station for the UE in the wireless network, the method including:
transmitting, to the first UE, a first request for visual positioning of the first UE, the visual positioning based at least in part on visual signals captured by a visual sensor of the first UE and on one or more radio positioning signals;
receiving video-based channel state information (vCSI) from the first UE, the vCSI based at least in part on the relative direction and on visual data captured by the first UE; and
transmitting the vCSI to a location server coupled to the base station.
Clause 45. The method of clause 44, wherein the visual data is associated with one or more wireless devices within visual range of the first UE.
Clause 46. The method of clause 45, wherein the first request indicates a distance associated with at least one of the one or more wireless devices.
Clause 47. The method of clause 45, wherein the one or more radio positioning signals are received by the first UE from one of the one or more wireless devices within visual range of the first UE.
Clause 48. The method of clause 45, wherein the first request further indicates a relative direction for pointing the visual sensor of the first UE, and wherein the method further includes:
transmitting, prior to transmitting the first request, a sidelink (SL) positioning request to the first UE requesting the first UE to determine positioning information associated with the relative direction;
receiving, from the first UE, a response to the SL positioning request associated with the relative direction based at least in part on the one or more radio positioning signals, wherein the one or more radio positioning signals are exchanged between the first UE and one of the one or more wireless devices.
Clause 49. The method of clause 45, wherein the vCSI is associated with a presence of at least one of the one or more wireless devices, wherein the method further includes:
transmitting a request to the first UE requesting radio positioning of one of the one or more wireless devices, the request for radio positioning based at least in part on the vCSI; and
receiving a response from the first UE based at least in part on the one or more radio positioning signals, wherein the one or more radio positioning signals are exchanged between the first UE and the one of the one or more wireless devices.
Clause 50. The method of clause 44, wherein the vCSI is determined based on the captured visual data using a trained machine learning model.
Clause 51. The method of clause 44, further including, prior to transmitting the first request:
transmitting a request for radio-based positioning of the first UE;
receiving one or more signals from the first UE based on the one or more radio positioning signals, the one or more radio positioning signals indicating one or more positioning measurements performed by the first UE;
wherein the first request is based at least in part on the one or more positioning measurements.
Clause 52. The method of clause 51, further including transmitting one or more signals to the first UE indicating one or more points of interest determined to be proximate to the first UE based on the one or more positioning measurements, wherein the visual data is based at least in part on the one or more points of interest.
Clause 53. A base station configured to support positioning of a user equipment (UE) in a wireless network, including:
an external interface configured to wirelessly communicate with entities in the wireless network;
at least one memory;
at least one processor coupled to the external interface and the at least one memory, wherein the at least one processor is configured to:
   transmit, to the first UE, a first request for visual positioning of the first UE, the visual positioning based at least in part on visual signals captured by a visual sensor of the first UE and on one or more radio positioning signals;
   receive video-based channel state information (vCSI) from the first UE, the vCSI based at least in part on the first request and on visual data captured by the first UE; and
   transmit the vCSI to a location server coupled to the base station.
Clause 54. The base station of clause 53, wherein the visual data is associated with one or more wireless devices within visual range of the first UE.
Clause 55. The base station of clause 54, wherein the first request indicates a distance associated with at least one of the one or more wireless devices.
Clause 56. The base station of clause 54, wherein the one or more radio positioning signals are received by the first UE from one of the one or more wireless devices within visual range of the first UE.
Clause 57. The base station of clause 54, wherein the first request further indicates a relative direction for pointing the visual sensor of the first UE, and wherein the at least one processor is further configured to:
transmit, prior to transmitting the first request, a sidelink (SL) positioning request to the first UE requesting the first UE to determine positioning information associated with the relative direction;
receive, from the first UE, a response to the SL positioning request associated with the relative direction based at least in part on the one or more radio positioning signals, wherein the one or more radio positioning signals are exchanged between the first UE and one of the one or more wireless devices.
Clause 58. The base station of clause 54, wherein the vCSI is associated with a presence of at least one of the one or more wireless devices, wherein the at least one processor is further configured to:
transmit a request to the first UE requesting radio positioning of one of the one or more wireless devices, the request for radio positioning based at least in part on the vCSI; and
receive a response from the first UE based at least in part on the one or more radio positioning signals, wherein the one or more radio positioning signals are exchanged between the first UE and the one of the one or more wireless devices.
Clause 59. The base station of clause 53, wherein the vCSI is determined based on the captured visual data using a trained machine learning model.
Clause 60. The base station of clause 53, wherein the at least one processor is further configured to, prior to transmitting the first request:
transmit a request for radio-based positioning of the first UE;
receive one or more signals from the first UE based on the one or more radio positioning signals, the one or more radio positioning signals indicating one or more radio positioning measurements performed by the first UE;
wherein the first request is based at least in part on the one or more radio positioning measurements.
Clause 61. The base station of clause 60, wherein the at least one processor is further configured to transmit one or more signals to the first UE indicating one or more points of interest determined to be proximate to the first UE based on the one or more radio positioning measurements, wherein the visual data is based at least in part on the one or more points of interest.
Clause 62. A first user equipment (UE), including:
means for receiving a first request for visual positioning of the first UE, the visual positioning based at least in part on visual signals captured by a visual sensor of the first UE and on one or more radio positioning signals;
means for capturing visual data based on the first request;
means for determining video-based channel state information (vCSI) based on the captured visual data; and
transmitting the vCSI to a network entity associated with the first UE.
Clause 63. The first UE of clause 62, wherein the visual data is associated with one or more wireless devices within visual range of the first UE.
Clause 64. The first UE of clause 63, wherein the one or more radio positioning signals are received by the first UE from one of the one or more wireless devices within visual range of the first UE.
Clause 65. The first UE of clause 63, wherein the first request includes a distance associated with at least one of the one or more wireless devices.
Clause 66. The first UE of clause 63, wherein the first request further indicates a relative direction for pointing the visual sensor of the first UE, and the first UE further includes:
means for receiving, prior to receiving the first request a sidelink (SL) positioning request requesting the first UE to determine positioning information associated with the relative direction;
means for receiving the one or more positioning signals from one of the one or more wireless devices; and
means for transmitting a response to the SL positioning request associated with the relative direction based at least in part on the one or more radio positioning signals.
Clause 67. The first UE of clause 65, wherein the relative direction indicates at least a threshold distance, wherein the vCSI is only determined for objects within the threshold distance of the first UE.
Clause 68. The first UE of clause 63, wherein the vCSI is associated with a presence of at least one of the one or more wireless devices, wherein the first UE further includes:
means for receiving a request from the network entity requesting radio positioning of one of the one or more wireless devices, the request for radio positioning based at least in part on the vCSI;
means for receiving the one or more radio positioning signals from the at least one of the one or more wireless devices; and
means for transmitting a response to the network entity based at least in part on the one or more radio positioning signals.
Clause 69. The first UE of clause 62, wherein the vCSI is determined based on the captured visual data using a trained machine learning model.
Clause 70. The first UE of clause 62, wherein the vCSI is based at least in part on one or more tags, the one or more tags indicating one or more zone properties associated with the visual data.
Clause 71. The first UE of clause 70, wherein the one or more zone properties include one or more of an indoor zone category, an outdoor zone category, a sky zone category, a ground zone category, a reflection zone category, a blockage zone category, a room size zone category.
Clause 72. The first UE of clause 62, wherein the first request further indicates a category of object of interest, wherein the vCSI is determined based at least in part on the category of object of interest.
Clause 73. The first UE of clause 62, further including, prior to receiving the first request:
means for receiving a request for radio-based positioning of the first UE;
means for receiving the one or more radio positioning signals based on the request for radio-based positioning;
means for determining one or more radio positioning measurements based on the one or more radio positioning signals; and
means for transmitting one or more signals to the network entity indicating the one or more radio positioning measurements;
wherein the first request is based at least in part on the one or more radio positioning measurements.
Clause 74. The first UE of clause 73, further including receiving one or more signals from the base station indicating one or more points of interest determined to be proximate to the first UE based on the one or more radio positioning measurements, wherein the visual data is based at least in part on the one or more points of interest.
Clause 75. The first UE of clause 62, further including, prior to receiving the first request, means for reporting one or more capabilities to the base station associated with determining the vCSI, the one or more capabilities comprising one or more of a number of cameras coupled to the first UE, one or more visual zoom capabilities associated with the first UE, one or more ranges of motion associated with capturing the visual data, and one or more visual resolutions associated with capturing the visual data.
Clause 76. A location server in a wireless network, including:
means for transmitting, to the first UE, a first request for visual positioning of a first UE, the visual positioning based at least in part on visual signals captured by a visual sensor of the first UE and on one or more radio positioning signals;
means for receiving video-based channel state information (vCSI) from the first UE, the vCSI based at least in part on the first request and on visual data captured by the first UE; and
means for determining a location of the first UE based at least in part on the one or more radio positioning signals and the vCSI.
Clause 77. The location server of clause 76, wherein the visual data is associated with one or more wireless devices within visual range of the first UE.
Clause 78. The location server of clause 77, wherein the first request indicates a distance associated with at least one of the one or more wireless devices.
Clause 79. The location server of clause 77, wherein the one or more radio positioning signals are received by the first UE from one of the one or more wireless devices within visual range of the first UE.
Clause 80. The location server of clause 77, wherein the first request further indicates a relative direction for pointing the visual sensor of the first UE, and location server further includes:
means for transmitting, prior to transmitting the first request, a sidelink (SL) positioning request to the first UE requesting the first UE to determine positioning information associated with the relative direction;
means for receiving, from the first UE, a response to the SL positioning request associated with the relative direction based at least in part on the one or more radio positioning signals, wherein the one or more radio positioning signals are exchanged between the first UE and one of the one or more wireless devices.
Clause 81. The location server of clause 77, wherein the vCSI is associated with a presence of at least one of the one or more wireless devices, wherein the location server further includes:
means for transmitting a request to the first UE requesting radio positioning of one of the one or more wireless devices, the request for radio positioning based at least in part on the vCSI; and
means for receiving a response from the first UE based at least in part on the one or more radio positioning signals, wherein the one or more radio positioning signals are exchanged between the first UE and the one of the one or more wireless devices.
Clause 82. The location server of clause 76, wherein the vCSI is determined based on the captured visual data using a trained machine learning model.
Clause 83. The location server of clause 76, further comprising:
means for transmitting, prior to transmitting the first request, a request for radio-based positioning of the first UE;
means for receiving one or more signals from the first UE based on the one or more radio positioning signals, the one or more radio positioning signals indicating one or more radio positioning measurements performed by the first UE;
wherein the first request is based at least in part on the one or more radio positioning measurements.
Clause 84. The location server of clause 83, further including means for transmitting one or more signals to the first UE indicating one or more points of interest determined to be proximate to the first UE based on the one or more radio positioning measurements, wherein the visual data is based at least in part on the one or more points of interest.
Clause 85. The location server of clause 76, further including means for receiving, prior to transmitting the first request, one or more messages from the first UE indicating one or more capabilities of the first UE associated with determining the vCSI, the one or more capabilities comprising one or more of a number of cameras coupled to the first UE, one or more visual zoom capabilities associated with the first UE, one or more ranges of motion associated with capturing the visual data, and one or more visual resolutions associated with capturing the visual data.
Clause 86. A base station in a wireless network, including:
means for transmitting, to a first UE, a first request for visual positioning of the first UE, the visual positioning based at least in part on visual signals captured by a visual sensor of the first UE and on one or more radio positioning signals;
means for receiving video-based channel state information (vCSI) from the first UE, the vCSI based at least in part on the first request and on visual data captured by the first UE; and
means for the vCSI to a location server coupled to the base station.
Clause 87. The base station of clause 86, wherein the visual data is associated with one or more wireless devices within visual range of the first UE.
Clause 88. The base station of clause 87, wherein the first request indicates a distance associated with at least one of the one or more wireless devices.
Clause 89. The base station of clause 87, wherein the one or more radio positioning signals are received by the first UE from one of the one or more wireless devices within visual range of the first UE.
Clause 90. The base station of clause 87, wherein the first request further indicates a relative direction for pointing the visual sensor of the first UE, and wherein the base station further includes:
means for transmitting, prior to transmitting the first request, a sidelink (SL) positioning request to the first UE requesting the first UE to determine positioning information associated with the relative direction;
means for receiving, from the first UE, a response to the SL positioning request associated with the relative direction based at least in part on the one or more radio positioning signals, wherein the one or more radio positioning signals are exchanged between the first UE and one of the one or more wireless devices.
Clause 91. The base station of clause 87, wherein the vCSI is associated with a presence of at least one of the one or more wireless devices, wherein the method further includes:
means for transmitting a request to the first UE requesting radio positioning of one of the one or more wireless devices, the request for radio positioning based at least in part on the vCSI; and
means for receiving a response from the first UE based at least in part on the one or more radio positioning signals, wherein the one or more radio positioning signals are exchanged between the first UE and the one of the one or more wireless devices.
Clause 92. The base station of clause 86, wherein the vCSI is determined based on the captured visual data using a trained machine learning model.
Clause 93. The base station of clause 86, further including:
means for transmitting, prior to transmitting the first request, a request for radio-based positioning of the first UE;
means for receiving one or more signals from the first UE based on the one or more radio positioning signals, the one or more radio positioning signals indicating one or more radio positioning measurements performed by the first UE;
wherein the first request is based at least in part on the one or more radio positioning measurements.
Clause 94. The base station of clause 93, further including means for transmitting one or more signals to the first UE indicating one or more points of interest determined to be proximate to the first UE based on the one or more radio positioning measurements, wherein the visual data is based at least in part on the one or more points of interest.

Therefore, it is intended that claimed subject matter not be limited to the particular examples disclosed, but that such claimed subject matter may also include all aspects falling within the scope of appended claims, and equivalents thereof.

1. A method performed by a first user equipment (UE) for supporting positioning of the UE in a wireless network, comprising:
receiving a first request for visual positioning of the first UE, the visual positioning based at least in part on visual signals captured by a visual sensor of the first UE and on one or more radio positioning signals;
capturing visual data based on the first request;
determining video-based channel state information (vCSI) based on the captured visual data; and
transmitting the vCSI to a network entity associated with the first UE.

2. The method of claim 0, wherein the visual data is associated with one or more wireless devices within visual range of the first UE.

3. The method of claim 2, wherein the one or more radio positioning signals are received by the first UE from one of the one or more wireless devices within visual range of the first UE.

4. The method of claim 2, wherein the first request includes a distance associated with at least one of the one or more wireless devices.

5. The method of claim 2, wherein the first request indicates a relative direction for pointing the visual sensor of the first UE.

6. The method of claim 5, further comprising:
receiving, prior to receiving the first request, a sidelink (SL) positioning request requesting the first UE to determine positioning information associated with the relative direction;
receiving the one or more radio positioning signals from one of the one or more wireless devices; and
transmitting a response to the SL positioning request associated with the relative direction based at least in part on the one or more radio positioning signals.

7. The method of claim 2, wherein the vCSI is associated with a presence of at least one of the one or more wireless devices, wherein the method further comprises:
receiving a request from the network entity requesting radio positioning of one of the one or more wireless devices, the request for radio positioning based at least in part on the vCSI;
receiving the one or more radio positioning signals from the at least one of the one or more wireless devices; and
transmitting a response to the network entity based at least in part on the one or more radio positioning signals.

8. The method of claim 1, wherein the first request indicates at least a threshold distance, wherein the vCSI is only determined for objects within the threshold distance of the first UE.

9. The method of claim 0, wherein the vCSI is determined based on the captured visual data using a trained machine learning model.

10. The method of claim 1, wherein the vCSI is based at least in part on one or more tags, the one or more tags indicating one or more zone properties associated with the visual data.

11. The method of claim 1, wherein the first request further indicates a category of object of interest, wherein the vCSI is determined based at least in part on the category of object of interest.

12. The method of claim 1, further comprising, prior to receiving the first request:
receiving a request for radio-based positioning of the first UE;
receiving the one or more radio positioning signals based on the request for radio-based positioning;
determining one or more radio positioning measurements based on the one or more radio positioning signals; and
transmitting one or more signals to the network entity indicating the one or more radio positioning measurements,
wherein the first request is based at least in part on the one or more radio positioning measurements.

13. The method of claim 12, further comprising receiving one or more signals from the network entity indicating one or more points of interest determined to be proximate to the first UE based on the one or more radio positioning measurements, wherein the visual data is based at least in part on the one or more points of interest.

14. The method of claim 1, further comprising, prior to receiving the first request, reporting one or more capabilities to the network entity associated with determining the vCSI, the one or more capabilities comprising one or more of a number of cameras coupled to the first UE, one or more visual zoom capabilities associated with the first UE, one or more ranges of motion associated with capturing the visual data, one or more visual resolutions associated with capturing the visual data.

15. A first user equipment (UE) configured to transmit location information messages in a wireless network, comprising:
a wireless transceiver configured to wirelessly communicate with entities in the wireless network;
at least one memory; and
at least one processor coupled to the wireless transceiver and the at least one memory, wherein the at least one processor is configured to:
receive a first request for visual positioning of the first UE, the visual positioning based at least in part on visual signals captured by a visual sensor of the first UE and on one or more radio positioning signals;
capture visual data based on the first request;
determine video-based channel state information (vCSI) based on the captured visual data; and
transmit the vCSI to a network entity associated with the first UE.

16. The first UE of claim 15, wherein the visual data is associated with one or more wireless devices within visual range of the first UE.

17. The first UE of claim 16, wherein the one or more radio positioning signals are received by the first UE from one of the one or more wireless devices within visual range of the first UE.

18. The first UE of claim 16, wherein the first request includes a distance associated with at least one of the one or more wireless devices.

19. The first UE of claim 16, wherein the first request indicates a relative direction for pointing the visual sensor of the first UE.

20. The first UE of claim 19, wherein the at least one processor is further configured to:
receive, prior to receiving the first request a sidelink (SL) positioning request requesting the first UE to determine positioning information associated with the relative direction;
receive the one or more radio positioning signals from one of the one or more wireless devices; and
transmit a response to the SL positioning request associated with the relative direction based at least in part on the one or more radio positioning signals.

21. The first UE of claim 16, wherein the vCSI is associated with a presence of at least one of the one or more wireless devices, wherein the at least one processor is further configured to:
receive a request from the network entity requesting radio positioning of one of the one or more wireless devices, the request for radio positioning based at least in part on the vCSI;
receive the one or more radio positioning signals from the at least one of the one or more wireless devices; and
transmit a response to the network entity based at least in part on the one or more radio positioning signals.

22. The first UE of claim 15, wherein the vCSI is determined based on the captured visual data using a trained machine learning model.

23. The first UE of claim 15, wherein the at least one processor is further configured to, prior to receiving the first request:
receive a request for radio-based positioning of the first UE;
receive the one or more radio positioning signals based on the request for radio-based positioning;
determine one or more radio positioning measurements based on the one or more radio positioning signals; and
transmit one or more signals to the network entity indicating the one or more radio positioning measurements,
wherein the first request is based at least in part on the one or more radio positioning measurements.

24. The first UE of claim 23, wherein the at least one processor is further configured to receive one or more signals from the network entity indicating one or more points of interest determined to be proximate to the first UE based on the one or more radio positioning measurements, wherein the visual data is based at least in part on the one or more points of interest.

25. The first UE of claim 15, wherein the at least one processor is further configured to, prior to receiving the first request, report one or more capabilities to the network entity associated with determining the vCSI, the one or more capabilities comprising one or more of a number of cameras coupled to the first UE, one or more visual zoom capabilities associated with the first UE, one or more ranges of motion associated with capturing the visual data, and one or more visual resolutions associated with capturing the visual data.

26. A method for supporting positioning of a first user equipment (UE) in a wireless network, performed by a location server in the wireless network and comprising:
transmitting, to the first UE, a first request for visual positioning of the first UE, the visual positioning based at least in part on (i) visual signals captured by a visual sensor of the first UE and (ii) one or more radio positioning signals exchanged between the first UE and one or more wireless devices within visual range of the first UE, the one or more wireless devices comprising a second UE;
receiving video-based channel state information (vCSI) from the first UE, the vCSI based at least in part on the first request and on visual data captured by the first UE, wherein the visual data is associated with the one or more wireless devices; and
determining a location of the first UE based at least in part on the one or more radio positioning signals and the vCSI.

27. (canceled)

28. The method of claim 26, wherein the first request indicates (i) a distance associated with at least one of the one or more wireless devices or (ii) a relative direction for pointing the visual sensor of the first UE.

29. (canceled)

30. (canceled)

31. The method of claim 26, wherein the vCSI is associated with a presence of at least one of the one or more wireless devices, wherein the method further comprises:
transmitting a request to the first UE requesting radio positioning of one of the one or more wireless devices, the request for radio positioning based at least in part on the vCSI; and
receiving a response from the first UE based at least in part on the one or more radio positioning signals.

32-44. (canceled)

45. A method for supporting positioning of a first user equipment (UE) in a wireless network by a serving base station for the UE in the wireless network, the method comprising:
transmitting, to the first UE, a first request for visual positioning of the first UE, the visual positioning based at least in part on visual signals captured by a visual sensor of the first UE and on one or more radio positioning signals;
receiving video-based channel state information (vCSI) from the first UE, the vCSI based at least in part on the first request and on visual data captured by the first UE, wherein the visual data is associated with one or more wireless devices within visual range of the first UE, the one or more wireless devices comprising a second UE; and
transmitting the vCSI to a location server coupled to the base station.

46. (canceled)

47. The method of claim 45, wherein the first request indicates (i) a distance associated with at least one of the one or more wireless devices or (ii) a relative direction for pointing the visual sensor of the first UE.

48-62. (canceled)
